(19) United States
(12) Patent Application Publication
(10) Pub. No.: US 2026/0330521 A1
(43) Pub. Date: Oct. 22, 2026

(54) METHOD, MEDIUM, AND SYSTEM FOR VIRTUAL AGENTS TO HELP CUSTOMERS AND BUSINESSES

(71) Applicant: Voicemonk, Inc., Sunnyvale, CA (US)

(72) Inventors: Jagadeshwar Nomula, Sunnyvale, CA (US); Vinesh Gudla, Pleasanton, CA (US); Vineel Yalamarthy, Rajahmundry (IN)

(73) Assignee: Voicemonk, Inc., Sunnyvale, CA (US)

(21) Appl. No.: 19/529,102

(22) Filed: Feb. 3, 2026

Related U.S. Application Data
(63) Continuation-in-part of application No. 19/255,827, filed on Jun. 30, 2025, now Pat. No. 12,572,967.
Application No. 19/255,827 is a continuation of application No. 18/676,471, filed on May 28, 2024, now Pat. No. 12,346,945.
Application No. 18/676,471 is a continuation of application No. 18/465,186, filed on Sep. 12, 2023, now Pat. No. 11,995,698.
Application No. 18/465,186 is a continuation of application No. 17/323,287, filed on May 18, 2021, now Pat. No. 12,039,583.
Application No. 17/323,287 is a continuation of application No. 15/356,512, filed on Nov. 18, 2016, now Pat. No. 11,068,954.
(63) Continuation-in-part of application No. 16/245,188, filed on Jan. 10, 2019, now Pat. No. 12,639,593.
(60) Provisional application No. 62/257,722, filed on Nov. 20, 2015.
(60) Provisional application No. 62/275,043, filed on Jan. 5, 2016.
(60) Provisional application No. 62/318,762, filed on Apr. 5, 2016.
(60) Provisional application No. 62/616,428, filed on Jan. 12, 2018.

(30) Foreign Application Priority Data
Jul. 9, 2025 (IN) 202546065621
Jul. 24, 2025 (IN) 202546070524
Sep. 6, 2025 (IN) 202546084709
Nov. 11, 2025 (IN) 202546114226

(51) Int. Cl. G06Q 30/0601; G06F 16/957

(52) U.S. Cl. CPC G06Q 30/0617; G06F 16/957; G06Q 30/0629

(57) ABSTRACT

A computer-implemented method for controlling a graphical user interface (GUI) of a software application executing on a client device is disclosed. The method includes receiving a natural-language instruction specifying a user goal and acquiring pixel data representing a current visual state of the GUI. Based on the pixel data and the natural-language instruction, the method generates a plan comprising one or more user-interface operations referenced to pixel regions of the GUI. At least one operation is executed by injecting an operating system-level input event at coordinates derived from a referenced pixel region. The method further performs closed-loop verification by re-acquiring pixel data after execution and determining whether the user goal is satisfied. In certain embodiments, plan generation jointly processes pixel data, language input, and application map information, and may include region localization, action simulation using a world action model, iterative planning, and adaptive routing between local and remote models.

### CROSS-REFERENCE TO RELATED APPLICATIONS

This application is a continuation-in-part of U.S. application Ser. No. 19/255,827, filed Jun. 30, 2025, which is a continuation of application Ser. No. 18/676,471, filed May 28, 2024, which is a continuation of application Ser. No. 18/465,186, filed Sep. 12, 2023, which is a continuation of application Ser. No. 17/323,287 filed May 18, 2021, which is a continuation of application Ser. No. 15/356,512, filed Nov. 18, 2016, which claims benefit of provisional Application Nos. 62/257,722, 62/275,043, and 62/318,762, filed Nov. 20, 2015, Jan. 5, 2016, and Apr. 5, 2016, respectively.

Further, the present application is also a continuation-in-part of U.S. application Ser. No. 16/245,188 filed on Jan. 10, 2019, which is a continuation of provisional application 62/616,428 filed on Jan. 12, 2018.

Further, the present application claims benefit of Indian Application No. 202546065621, with title MULTIMODAL SENTIMENT ENGINE FOR VIRTUAL AGENT SYSTEMS filed Jul. 9, 2025, Indian Application No. 202546084709, with title THREE-DIMENSIONAL VISUAL MAPPING SYSTEM FOR INSTORE VIRTUAL AGENT NAVIGATION filed Sep. 6, 2025, Indian Application No. 202546070524, with title URGENCY/UNEASINESS SCORING WITH DYNAMIC ESCALATION FOR VIRTUAL AGENT SYSTEMS filed Jul. 24, 2025, and Indian Application No. 202546114226, with title VIRTUAL AGENT FOR PIXEL-BASED REASONING AND ACTION COORDINATION filed Nov. 11, 2025. The entire disclosures of all said prior applications are hereby incorporated by reference.

### DESCRIPTION OF RELATED ART

Customers browse through websites or software applications to look for products of interest to them. A customer can use a keyboard to enter keywords into the search box for which the website displays search results corresponding to the entered input. Further, the customer browses through the search results, filters them to select an item and either purchases it or adds it to the cart. In case the customer is interested in different products, they need to go back to the search box and enter a different search query. The same procedure needs to be repeated, which becomes tedious. Further, such websites and software applications are designed to work sequentially. If the customer wishes to add or search two or more items at the same time, it is impossible for them to do so since the customer needs to access different web pages to view different products.

Additionally, with an increase in the dependence of the web, many people now prefer completing a variety of work online instead of going out to physical stores. In physical stores, there are store attendants and employees who can help a customer while they are buying a product. However, when the same product is bought online, no such help is offered by conventional systems. When a customer wishes to place an order or clear doubts regarding a product, they make a call to an organization or a customer representative. Many times, a customer representative may not be available to talk to the customer. Other times, the customer is made to wait for long durations of time till they are connected to a customer representative. In such cases, the customer can feel frustrated due to the bad customer service. Conventional systems do not address this issue, which leads to an increase in time and effort spent by a customer.

Additionally, a customer cannot checkout multiple items in the same action and is forced to do actions in a sequence. Thus, the conventional systems failed to solve the above problems resulting in bad customer experience, which is not desirable. Further, with an increase in the number of consumers shopping online, it is of prime importance to improve customer experience, to increase revenue.

In addition, while customers experience the above discussed problems in their online engagement, brick and mortar stores have their own share of problems. In a brick and mortar store, products are stored in racks spread across the floor of the store. Often, it is difficult to locate the products in the store. Locating the products may require the customers or store assistants to browse through various racks in the store, which results in inefficient utilization of time and resources. In view of the foregoing discussion, there is a need to overcome the above problems and improve customer experience.

### SUMMARY OF THE INVENTION

The present invention provides a computer-implemented method and system for controlling a graphical user interface (GUI) of a software application in a manner that is independent of application-specific programmatic interfaces. The invention enables a software agent to interact with a GUI based on visual pixel data and natural-language goals, rather than relying on selectors, accessibility trees, or internal application code that may be unavailable, unstable, or obfuscated.

In accordance with one aspect of the invention, a natural-language instruction specifying a user goal is received, and pixel data representing a current visual state of the GUI is acquired. Using the pixel data and the natural-language instruction, the system generates a plan comprising one or more user-interface operations that are explicitly referenced to pixel regions of the GUI. The planned operations are executed by injecting operating system-level input events, such as mouse or keyboard events, at coordinates derived from the referenced pixel regions, thereby emulating human interaction at the operating system layer.

In another aspect, the invention performs closed-loop verification by re-acquiring pixel data after execution of a user-interface operation and determining whether the user goal has been satisfied based on the updated visual state. When an expected outcome is not observed, the system may re-localize interface elements, re-plan actions, or fall back to alternative execution mechanisms, enabling robust error recovery in dynamic or unpredictable interfaces.

In further embodiments, plan generation and action selection may be enhanced using region localization, action simulation via a world action model, iterative planning loops, and adaptive routing between local and remote inference models based on privacy, resource availability, or execution risk. The invention may further employ non-generative masked-latent visual encoders and federated learning to improve efficiency and privacy.

Overall, the invention enables reliable, application-agnostic GUI control through pixel-based perception, goal-driven planning, OS-level execution, and visual feedback, providing a technical improvement over conventional automation systems that depend on fragile or application-specific interfaces.

Other objects, features, and advantages of the present disclosure will become apparent from the following detailed description. It should be understood however, that the detailed description and specific examples, while indicating preferred implementations of the present disclosure, are given by way of illustration only and various modifications may naturally be performed without deviating from the present disclosure.

### BRIEF DESCRIPTION OF DRAWINGS

Implementations are illustrated by way of example and not limitation in the Figures of the accompanying drawings, in which like references indicate similar elements and in which:

FIG. 1 is an exemplary block diagram illustrating a virtual agent 100 comprising a virtual agent server 104, in accordance with an implementation;

FIG. 2 is an exemplary block diagram 200 illustrating interactions between a virtual agent client 202 and an exemplary virtual agent server 204, in accordance with an implementation;

FIG. 3 illustrates schemes and components which may be used to update dialogue states for a dialogue service, in accordance with an implementation;

FIG. 4 illustrates interactions between a virtual agent client 202 and a browser in the process of instantiating actions for a user, in accordance with an implementation;

FIG. 5 illustrates a flowchart illustrating the enabling of a virtual agent 100 coupled to a virtual agent server 104 to handle customer service calls, in accordance with an implementation;

FIG. 6 illustrates a flowchart 600 illustrating a virtual agent 100 helping a user in finding a physical route, in accordance with an implementation; and

FIG. 7 illustrates working of the virtual agent client 202 and virtual agent server 104 integrated with an e-commerce application 700, in accordance with an embodiment.

FIG. 8 is the block diagram of the improved virtual agent system of the present invention with a Multimodal Sentiment Engine (MSE 800) inserted between context understanding (806) and dialogue module (808).

FIG. 9 is a flowchart of the multimodal processing disclosed by the present invention: capture→feature extraction→fusion→threshold logic→adaptive actions.

FIG. 10 is a sequence diagram of a user session disclosed by the present invention, showing sentiment score rising and triggering alternative recommendations, then escalation.

FIG. 11 is the system architecture of the three-dimensional visual mapping system disclosed herein for instore virtual agent navigation comprising of an imaging vehicle (1120), ultra-wide band anchors (1130(a-n)), store map database (1160), virtual agent server, and a user mobile client (1170).

FIG. 12 is a flowchart of the map generation workflow disclosed by the present invention: capture→coordinate tagging→clustering→3D map creation→DB storage.

FIG. 13 is a sequence diagram of the user routing disclosed by the present invention, showing query intake, map lookup, path computation, and turn by turn guidance.

FIG. 14 is the block diagram of virtual agent system with urgency/uneasiness scoring engine (1406) integrated within the architecture of the virtual agent system disclosed and claimed by the parent patent.

FIG. 15 is a flowchart of the urgency/uneasiness scoring disclosed by the present invention: behavioral capture→feature extraction→scoring→threshold check→escalation or priority handling.

FIG. 16 is an example timeline: rising urgency score prompts action reordering; subsequent uneasiness spike triggers human hand-off.

FIG. 17 is an exemplary block diagram illustrating software modules of a system 1700 for recommending content and actions based on user behaviour, in accordance with an embodiment.

FIG. 18 is a flowchart 1800 illustrating the steps involved in building a generalized model 208a, in accordance with an embodiment.

FIG. 19 is a flowchart 1900 illustrating the steps involved in building a personalized model 308a of the behaviour analyzer 1702, in accordance with an embodiment.

FIG. 20A is a flowchart 2000 of an exemplary method for recommending content and predicting user actions, by the behaviour analyzer 1702, in accordance with an embodiment.

FIG. 20B, FIG. 20C, FIG. 20D, FIG. 20E, and FIG. 20F illustrate user interfaces enabled by the behaviour analyzer 1702, in accordance with an embodiment.

FIG. 21 is a flowchart of an exemplary method 2100 enabled by a virtual agent facilitated by the behaviour analyzer 1702, in accordance with an embodiment.

FIG. 22 is a block diagram illustrating hardware elements of the system 1700 of FIG. 17, in accordance with an embodiment.

FIG. 23 is the prior art architecture viz., virtual agent client/server architecture with dialogue and context modules.

FIG. 24 is the improved virtual agent architecture with Screen Perception, Multimodal Reasoner, JEPA Encoder, World Action Model (WAM), ReAct Planner, Tool Router, Action Executor, Verifier, Gate.

FIG. 25 is a flowchart demonstrating the process flow viz., capture pixels→fuse with NL intent+map→propose actions→simulate→(WAM)→act (UI/tool)→verify→iterate/fallback.

FIG. 26 is an illustration of the pixel-level localization of fields 5 and controls; coordinate transforms (DPR, scroll, rotation); OS event injection.

FIG. 27 is an illustration of the JEPA-style training (masked region prediction) and action prototype heads (click/drag/type/scroll/tool).

FIG. 28 is an illustration of the WAM learning from (screen, action, next screen) triples across diverse apps; value/success heads; tool effect heads.

FIG. 29 is an illustration of the ReAct loop timeline showing alternating UI actions and tool calls with observation of results and pixel recapture.

FIG. 30 is an illustration of the Local/Remote gating features (confidence, privacy, resource, network) and decision boundaries; hybrid modes.

### DETAILED DESCRIPTION

In the following detailed description of exemplary implementations of the disclosure in this section, specific exemplary implementations in which the disclosure may be practiced are described in sufficient detail to enable those skilled in the art to practice the disclosed implementations. However, it is to be understood that the specific details presented need not be utilized to practice implementations of the present disclosure. The following detailed description is, therefore, not to be taken in a limiting sense, and the scope of the present disclosure is defined by the appended claims and equivalents thereof

### Overview

A customer using websites and software applications can have better customer experience using virtual agents 100. A virtual agent 100 can speak with a customer in a natural voice. The virtual agent 100 can start with a pleasant greeting in a personalized voice and can ask the customer what they would like to do. The virtual agent 100 can use input from the customer that is in the form of voice, speech, facial expressions, head movement and eye movement inputs. The virtual agent 100 processes the input from the customer, considers different scenarios and presents suggestions to help the customers. Further, the virtual agent 100 presents the customer with one or more options for execution. The customer's chosen option can be executed by the virtual agent 100. Further, the virtual agent 100 can converse with the customer using natural language speech as a customer service representative. Additionally, the virtual agent 100 can answer questions asked by the customer regarding products or services available, and location of products within a commercial establishment.

The virtual agent 100 may be used to execute one or more actions desired by the user based on received user input. The virtual agent 100 may store one or more correlations between actions available in a software application. Further, the virtual agent 100 may associate one or more actions with tags describing the actions. The virtual agent 100 may process user inputs and use the tags associated with actions to identify the action desired by the user. Further, the virtual agent 100 may execute one or more actions based on the user's desired action and the correlation between actions in a software application. An example of actions carried out in a website may be: search, sort, select, compare and submit, among others.

As an example, a virtual agent 100 may identify one or more actions on a software application or a website and associate each action with a descriptive tag. When a user says “show me the latest mobile phones available today.”, the virtual agent 100 may understand that the user's desired action is a “search” action. Hence, the virtual agent 100 may execute an action with a tag related to “search”, and associate a context of “mobile phones” with the “search” action.

### Virtual Agent System

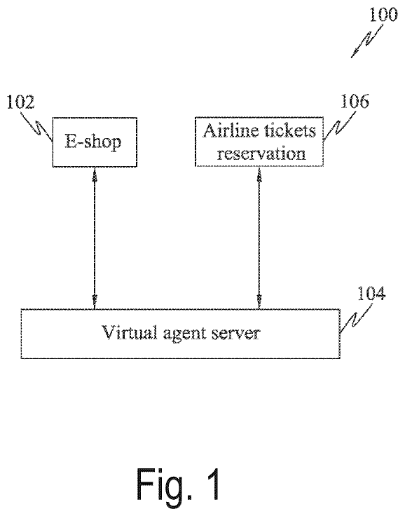

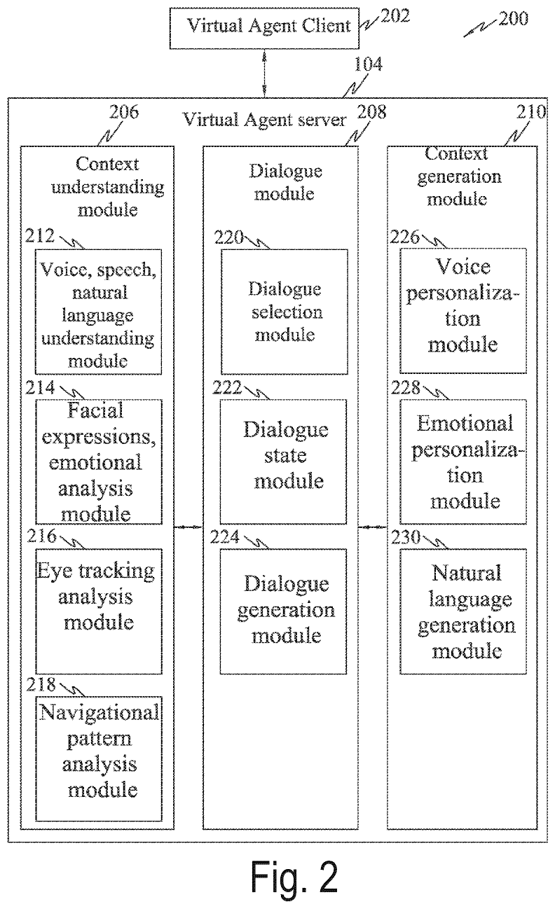

FIG. 1: depicts a diagram illustrating an exemplary architecture of a client-server based virtual agent system 100, in accordance with an implementation. A backend virtual agent server 104 may be coupled to a virtual agent client 202 (shown in FIG. 2) to interact with users. The virtual agent server 104 may interact with various websites or software applications, for example, an e-shop 102. The virtual agent server 104 may complete one or more tasks for the user such as booking appointments, buying tickets or placing orders, among other tasks done through a website or a software application. One example for a software application may be an Airline tickets reservation 106 where the user may instruct the virtual agent 100 to check flight rates or book tickets, among other tasks. Further examples may include buying movie tickets, tickets to theatre shows and concerts, among others.

In an embodiment, the virtual agent is a third-party application configured to interface and function with software applications, such as e-commerce applications, among others. Hence, a small or medium sized e-commerce player can enable his users to use the functionality enabled by the virtual agent by integrating the virtual agent with the eCommerce application, without the need to develop the functionality of the virtual agent specifically for his/her eCommerce application.

In an implementation, the virtual agent server 104 may receive one or more voice, speech, facial, head motion and eye tracking inputs, among others, from a virtual agent client 202 and may understand the inputs using a context understanding module 206. Further, the virtual agent server 104 may prepare a response with speech, voice and emotions using the context generation module 210. Further, the virtual agent client 202 may share the response with the user.

In an implementation, FIG. 2 depicts a diagram illustrating interactions between a virtual agent client 202 and an exemplary virtual agent server 104, exemplary components of the virtual agent server 104, and interactions between the components of the virtual agent server 104, in accordance with one or more implementations of the present disclosure.

In an implementation, the virtual agent 100 may comprise a virtual agent client 202 which may be coupled to a backend virtual agent server 104 wherein the virtual agent client 202 and the virtual agent server 104 may work together to complete a task of the user.

In an implementation, the virtual agent client 202 may be provided in a website or a software application to interact with users. The virtual agent client 202 present in the browser of the website or the mobile application may be implemented by software. Further, in an implementation, the virtual agent client 202 may be implemented in one of a native, JavaScript or html code, among other coding languages that exist or may exist in the future.

In an implementation, the virtual agent client 202 may start to engage the user in case they open a software application or website. The virtual agent client 202 may enable the input given by the user to be used for determining the context of the user. Further, it may enable execution of one or more actions in the software application or website as requested by the user. These actions may include one or more of a search, viewing an item, a checkout action and filtering results, among others in a retailing context.

In an implementation, the virtual agent 100 may comprise a virtual agent server 104 which may further comprise a context understanding module 206, a dialogue module 208 and a context generation module 210. In an implementation, the virtual agent server 104 may process inputs from the user using context understanding module 206. Such inputs may include one or more of voice, speech, facial, head motion, application navigation, or eye tracking inputs, among others. The dialogue module 208 may keep track of the spoken dialogue conversation between the virtual agent 100 and the user; and may provide a dialogue service to enable spoken dialogue interaction between the user and the virtual agent 100. Further, the virtual agent server 104 may use the context generation module 210 to determine appropriate speech, voice and emotions for the communication to be made by the virtual agent client 202 with the user.

The context understanding module 206 may further include a voice, speech and natural language understanding module 212, a facial expressions and emotional analysis module 214, an eye-tracking analysis module 216 and a navigational patterns analysis module 218.

In an implementation, the voice, speech and natural language understanding module 214 may process the content of the user's speech to understand the inputs and requirements of the user. The voice, speech and natural language understanding module 214 may understand the speech context from the user and determine the user's needs. The context may be derived from explicit inputs given by the user and may correspond to an action desired by the user. Further, the determined context may be incorporated while executing one or more actions on behalf of the user.

The speech context may comprise textual words used by the user in the current session and/or previous “m” sessions. Further, “m” may be manually configured or tuned for a software application using one or more algorithms such as Machine Learning, among others.

In an implementation, the voice, speech and natural language understanding module 214 may assign weights to tokens (individual words) detected in the speech context using Term Frequency Inverted Document Frequency (tfidf) and the recency of the communication session. The voice, speech and natural language understanding module 214 may also assign appropriate weights to words detected in previous “m” sessions and may include them in the current communication session. The speech context may also include one or more explicit inputs or inferences from previous natural conversation sessions which are decayed using recency of occurrence. Further, the output displayed by the virtual agent 100 may depend on the context derived from these explicit inputs using current and previous communication sessions.

In an implementation, the voice, speech and natural language understanding module 214 may also determine a voice context of the user's communication session. The voice context may include one or more of the intensity of speech and frequency of the speech, among others.

In an implementation, the voice, speech and natural language understanding module 214 may use one or more slot filling algorithms to recognize text and interpret the conversation. Further, in case the virtual agent server 104 determines that more slots need to be filled, the dialogue state module 222 of the dialogue module 208 may use the voice, speech and natural language understanding module 214 of the context generation module 210 to ask one or more clarifying questions to the user. This may be done to increase engagement with the user and collect additional information from the user to fill the required slots.

In an implementation, the virtual agent 100 may estimate an age of the speaker from vocal cues. Age-related changes in anatomy and physiology may affect a person's vocal folds and vocal tract; hence, a person's age may be estimated using one or more vocal cues from the audio input comprising the speaker's voice. One or more vocal cues or measures such as jitter, shimmer, and Mel-frequency cepstral coefficients may be used to correlate the user's voice with age.

In an implementation, the context understanding module 206 may use manual rules followed by natural language analysis techniques to understand the verbal feedback of the user.

In an implementation, the facial expressions and emotional analysis module 214 within the context understanding module 206 may process the inputs received from the virtual agent client 202 to determine an emotional state of the user based on the reactions of the user. The facial expressions and emotional analysis module 214 may analyse one or more facial and head motion frames (e.g., sideways, upwards and downwards) of the user and process them by using one or more techniques such as predictive, machine learning or deep learning techniques, among others, to understand emotional reactions of the user.

In an implementation, the eye tracking analysis module 216 within the context understanding module 206 may include an eye tracking system that may receive one or more video recordings of the user from the virtual agent client 202 and process them to track the movement of the user's eyes across the device screen on which the website or software application is running. Further, the eye tracking analysis module 216 may process the tracked eye movements to determine one or more top ‘y’ positions viewed by the user on the device screen. Subsequently, the virtual agent 100 may decide on one or more courses of action based on these top ‘y’ positions.

In an implementation, the navigational patterns analysis module 218 within the context understanding module 206 may include a navigation pattern tracking system that may receive inputs of the user's navigation across the website/software application from the virtual agent client 202 and process them to track the user's navigation. Further, the navigational patterns analysis module 218 may process the tracked website navigation to determine one or more items of interest on the website that may have interested the user. Subsequently, the virtual agent 100 may decide on a course of action based on these items.

In an implementation, the dialogue module 208 may help to coordinate one or more actions between the context understanding module 206 and the context generation module 210. The dialogue module 208 may keep track of the spoken dialogue conversation between the virtual agent 100 and the user. Further, the dialogue module 208 may provide a dialogue service that allows spoken dialogue interaction between the user and the virtual agent 100.

In an implementation, the dialogue module 208 may process inputs received from the virtual agent client 202 to understand the context of the communication session with the user by using the context understanding module 206. Further, the dialogue module 208 may personalize user experience using the context generation module 210 after computing top ‘n’ weighted options of possible actions.

In an implementation, the dialogue module 208 may generate one or more clarification questions to comprehend the user's desired action with the help of the context understanding module 206. In case the dialogue module 208 comprehends the user's intention, it may map the intention to a user action in the application and send it back to the virtual agent client 202 along with a verbal confirmation. The dialogue module 208 may use one or more predictive or machine learning classification and/or ranking algorithms to process the context computed from the context understanding module 206. Further, it may map the context to a list of weighted actions to be executed by the virtual agent 100 on the website or software application.

In an implementation, an offline process may construct the mapping between actions or states and user commands. The association between the possible actions and the user commands may be determined by crawling the website or software application and determining associations between the possible actions and the user commands. This may be done by using one or more techniques such as pattern matching and/or entity name recognition techniques. This type of mapping may also be built by a manual configuration of rules.

In an implementation, a mapping in the dialogue module 208 may be executed as follows: the dialogue module 208 may determine the user's intention and may query the inventory of the website or software application to determine if it has any actions available for the user which may satisfying the user. The parameters required to complete the query may be manually configured or discovered by crawling the website or software application.

An example of a mapped action named “search action” may be described as follows:

| | |
|---|---|
| Event: | Search action |
| Input Box-Id: | “search-box” |
| Query: | {query output from context output module} |
| Button-Id: | “search-submit” |
| Action: | “click” |
| Voice output: | “I am searching {query output from context |
| | input module} for you. Please let me know |
| | if you want to change your search criteria.” |

In an implementation, the dialogue module 208 may share one or more of the mappings with the context generation module 210. Further, the context generation module 210 may work with the virtual agent client 202 to communicate the voice output in a personalized accent and instantiate actions for the user on the website or software application without the user's involvement.

In an implementation, as an example, the virtual agent 100 may assist the user while they are shopping online by conversing with the user and providing one or more suggestions to them. In this case, the user may have shared a verbal feedback such as “This dress is too dark and expensive”. In this case, the dialogue module 208 may first identify that the user is giving feedback based on one or more inputs corresponding to what the user was doing when they gave the feedback and what their previous actions were. These inputs may be determined by using a Hidden Markov model trained offline with feedback from context understanding module 206. Further, upon determining that the user's speech is a feedback dialogue, the dialogue module 208 may label each of the user's words to one or more item characteristics using a Recurrent Neural Network which may be trained offline.

In an implementation, as an example, the sentence “This dress is too dark and expensive” may be processed and understood by the virtual agent 100 as follows: a ‘dress’ may refer to a type of item, ‘dark’ may refer to the colour of the item and ‘expensive’ may refer to the price of the item. Further, upon determining one or more labels in the dialogue, the virtual agent 100 may determine if it has sufficient information needed to process the natural dialogue of the user. This may be done by evaluating it against a feedback natural dialogue slot configuration in the application. Further, in case the virtual agent 100 determines from the feedback from the dialogue module 208 that there is insufficient information to work with, the virtual agent 100 may ask one or more clarification questions such as “is the design of this dress okay?”. This may prompt the user to share more information that may then be processed to determine the needs of the user.

In an implementation, the dialogue module 208 may answer one or more questions raised by the user. This may be done by converting vocal questions into text annotating the tokens in the text with part of speech tags and matching the questions into preformatted question formats. Further, the dialogue module 208 may ask one or more clarification questions to the user, in case it determines that all the slots are not filled in the dialogue session for it to act on the user's behalf.

The dialogue service of the virtual agent 100 may be selected using the dialogue selection module 220. Different types of dialogues may be selected based on one or more of context, user personality and user requirements, among others.

In an implementation, the dialogue state module 222 in the dialogue module 208 may use the voice, speech and natural language understanding module 214 to ask one or more clarifying questions to the user to fill any required slots. Further, the dialogue module 208 may hold information corresponding to one or more possible actions for the user using the dialogue state module 222. The possible dialogue states may also be configured manually with weights by a programmer.

In an implementation, the virtual agent 100 may crawl a website or software application to identify one or more outward links, web-forms, and information that may be present in the website or software application. The virtual agent 100 may use pattern matching, hand written rules and one or more machine learning algorithms such as Hidden Markov Model (HMM) and Conditional Random Fields (CRF), among others, for identification of the links and web-forms. The virtual agent 100 may then add an action for each link and/or web form in the dialogue state module 222. These links and web forms may be tagged with one or more keywords and synonyms with the help of manual tagging, offline call and log analysis. This may be done to increase the match percentage related to voice conversations from the user.

In an implementation, as an example, a user may have said “Reserve Holiday Inn hotel”, and the virtual agent 100 did not understand the speech. The user may discontinue using the virtual agent 100 and may type “Holiday Inn” into the search box manually to make reservations in the hotel. In such a case, the virtual agent 100 may add a rule for that search action stating that in case the text in the input for the context understanding module 206 has a word similar to “Reserve *”, then the user may intend to reserve a hotel and hence the virtual agent 100 may need to send the appropriate action to the virtual agent client 202.

In an implementation, the dialogue module 208 may use previous logs of user interaction with the virtual agent 100 as training data. This training data may be used for building and improving one or more algorithms such as machine learning models and/or predictive algorithms in the context understanding module 206 and the dialogue module 208.

In an implementation, a Recurrent Neural Network may learn from the log data in case the user says “Reserve Holiday Inn hotel” and was not happy with virtual agent 100's response and may issue a Reservation action for “Holiday Inn”. In this case, the virtual agent 100 may tag ‘Reserve’ as an action and ‘Holiday Inn hotel’ as an input to the reservation action.

In an implementation, the dialog service of the virtual agent 100 may be generated using the dialogue generation module 224. Different types of dialogues may be generated based one or more of context, user personality and user requirements, among others.

In an implementation, the context generation module 210 may further include a voice personalization module 226, an emotional personalization module 228 and a natural language generation module 230.

In an implementation, the context generation module 210 may present the user with top ‘n’ options to choose in a verbal conversation. The context generation module 210 may determine the possible outputs or actions that the user may be interested in, given the current dialogue state of engagement between the user and the virtual agent 100.

In an implementation, the voice personalization module 226 may personalize the virtual agent 100's voice based one or more of the user's details. The virtual agent 100 may determine one or more user information including age group, gender, information processing speed and style of the user with the help of one or more predictive and machine learning methods. In some cases, the virtual agent 100 may have stored one or more of the user information mentioned above, in a database. Alternatively, one or more of the user information mentioned above may be collected from previous sessions.

After determining one or more user details such as age, gender, location, accent and other user information, the virtual agent 100 may decide to use different customizations and combinations of gender, voice, accent and language to communicate with the user using a plurality of modules to optimize engagement with the user. Different voice outputs may be trained offline for different personality types.

In an implementation, a generic parameterized HMM model for converting text to speech may be customized according to different personality types by asking different personality type persons to record the same text. This model may then be used in a speech synthesis model to generate appropriate sound waves with the right prosodic features for the text customized by the parameters determined during training. To determine the right voice for a user session, the virtual agent 100 may run one or more Collaborative Filtering algorithm and/or predictive algorithms with user's age, under, location, time of the day. Further, the virtual agent 100 may score each voice to choose one which may increase the engagement with the current user.

In an implementation, the emotional personalization module 228 may determine one or more emotions to be used in the dialogue service for the client. The virtual agent 100 may start its speech with a pleasant greeting in a personalized voice. Further, it, may ask the user one or more questions such as what they would like to do, and subsequently present the user with one or more top ‘x’ options in case the user opens a website or app for a retail store such as AMAZON.

In an implementation, in case the virtual agent server 104 has determined that more information may be required from the user, the natural language generation module 230 in the context generation module 210 may be used to provide questions to the user. This may be done to increase engagement with the user to collect more information to fill the required slots. Further, the natural language generation module 230 may generate appropriate responses during the conversation with the user.

In an implementation, taking an example of a merchant website, the context understanding module 206 may receive image input or speech of the user and may process them to understand the user's verbal, navigational and emotional inputs. Further, the context understanding module 206 may analyse the user's inputs to determine one or more items that the user is interested in. Subsequently, the context understanding module 206 may process the user's inputs to determine one or more parameters such as colour, fit, price and style of items that the user may be interested in. Further, the context understanding module 206 may analyse the inputs of the user, access additional information from the dialogue module 208 and send an output to the dialogue state module. The parameters considered by the context understanding module 206 may be manually configured at appropriate item levels or category levels of the item.

In an implementation, the virtual agent client 202 may communicate one or more inputs of the user to the context understanding module 206 to determine context and reasons for user unhappiness. The context understanding module 206 may process these inputs to determine the extent of user unhappiness and determine further suggestions or possible actions. Further, the virtual agent 100 may use the suggestions to generate various item suggestions for cross selling them to the user.

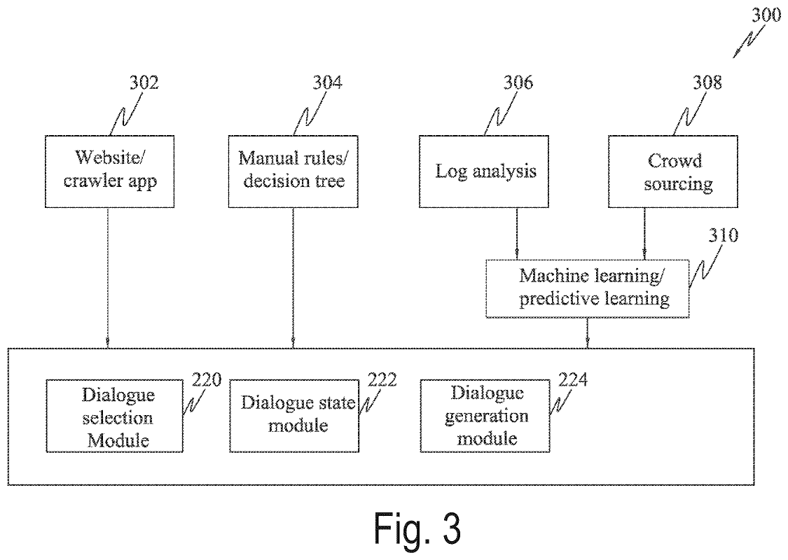

FIG. 3: depicts a diagram illustrating schemes and components which may be used to update dialogue states for a dialogue service (namely, a service provided to enable spoken dialogue interaction between a user and the virtual agent 100), according to one or more implementations of the present disclosure. In an implementation, one or more of the possible dialogue states may be configured manually with weights by a programmer as per step 304. In another implementation, the website or app may be crawled as shown at step 302 to determine one or more correlations between one or more of different actions on the webpage, outward links, web-forms, and information, among others, by using one or more methods such as pattern matching, hand written rules and machine learning algorithms such as Hidden Markov Model (HMM) and Conditional Random Fields (CRF), among others. Further, an action for one or more of the link(s) and/or web form(s) in the Dialogue State module 222 may be added. The links and web forms may be enriched with one or more keywords and synonyms though manual tagging, offline call and log analysis, among others, to increase match percentage to voice conversations from the user.

In an implementation, as an example, parsing through the logs the virtual agent may have determined that a person has said “Reserve Holiday Inn hotel”, but the virtual agent 100 did not understand the speech. The user gives up on the Virtual Agent 100 and types “Holiday Inn” manually into the search box and reserves the hotel. At step 304, we may add a rule for the search action saying that if the text in input to the NLU module 212 has got a pattern for “Reserve *” then the user intends to reserve a hotel and the Virtual Agent 100 should send appropriate action to the Virtual agent client 202 interacting with the user.

The correlations between the actions may be of different types such as sequential, hierarchical or lateral correlations. As an example, if a user asks “show me toy cars which are red”, then the virtual agent 100 will determine that two actions are desired, searching for a toy car and filtering only red ones. Here, search action needs to be executed before filter action, hence this could be an example of a hierarchical correlation. If a user asks “help me book tickets”, then the virtual agent 100 may sequentially execute actions to help the user book the start point, destination, time of flight, cost, and so on. In case of a lateral correlation, the user may use an e-commerce website and ask “Add one pound of bread to my cart and show me different jams”, in which case the actions for adding to the cart and showing jam need to be executed laterally. Thus, at least two of the actions on a website which are executed by the virtual agent 100 may be correlated sequentially, hierarchically, or laterally.

In an implementation, a virtual agent 100 may work like a virtual salesman by helping a user when they use a website or software application. The virtual agent 100 may process one or more types of implicit inputs corresponding to the user such as the user's facial expressions, voice, speech, visual and application navigation pattern clues to determine whether the user is unhappy with the browsed item. Further, these implicit inputs may be used to determine the sentiment of the user. The unhappiness of the user may be determined based on one or more of the user's facial expressions, speech, visual and application navigation clues. The virtual agent 100 may determine such details with the help of one or more predictive or machine learning code included in the code of the website or software application; or it may be co-located on the browser or on the virtual agent server 104. Further, the predictive or machine learning codes may process information related to the user including a duration for which the user has looked at the item, navigation patterns on the page, speech cues and vision context, among others, to generate a score for the user's unhappiness called an unhappiness score.

In an implementation, the unhappiness score may be generated by using a manually tuned formula based on the above features. Alternatively, an algorithm such as Linear Regression may be trained on previous interactions and/or crowd sourced data. This algorithm may also be used to generate the unhappiness score.

In an implementation, evaluation code for the unhappiness score may alternatively be stored in a remote server, in which case the virtual agent 100 on the website or software application may pass the context of the user to the remote server. Further, this remote server may send back an unhappiness score to the application. In some cases, the virtual agent 100 may determine that the user may be unhappy with the output results displayed by the virtual agent 100. In this case, the virtual agent 100 may suggest or carry out one or more actions to reduce the unhappiness of the user. These suggestions or actions may be based on some parameters in the software application and any provisions that address such parameters. As an example, in case the user is unhappy with a displayed item, the virtual agent 100 may suggest different sizes, prices or brands related to that item on the website. In an implementation, the virtual agent 100 may suggest alternatives for one or more factors such as price, shape, size, color, brand or manufacturer, among other suggestions which may be used during cross selling a product or a service to a user in a retailing context.

In an implementation, as an example, when the virtual agent 100 takes in an input such as “show me red toy cars” from a user using a software application, the user may directly be directed to a page showing red toy cars. If the user had done this search on his own, he would have first seen results for toy cars, and would then filter them. Thus, in the absence of the virtual agent 100, more than one output page would have been displayed for one or more desire actions.

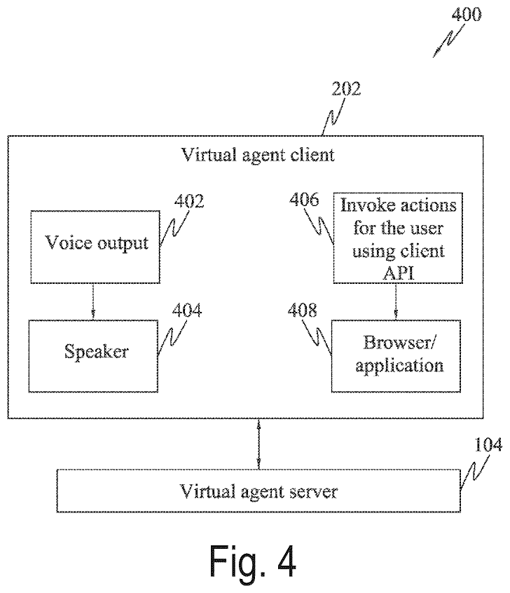

FIG. 4: depicts a diagram illustrating interactions between a virtual agent client 202 and a browser in the process of instantiating actions for a user, according to one or more implementations of the present disclosure. The virtual agent client 202 may invoke one or more actions on behalf of the user using the client application programming interface (API) as shown in step 406. The voice output at 402 may be delivered to the user by using an output device such as a speaker at step 404. For the above mapping, if the user says “Can you show me black shoes?”, the virtual agent client 202 Application Programming Interface that is implemented as a JavaScript and HTML snippet on the browser will fill the “search-box” with “black shoes” and click the “search-submit” button.

The virtual agent 100 may receive explicit inputs from the user of the software application and use these inputs to identify an action desired by the user to be performed and identify a context corresponding to the action. Further, based on the desired action, the virtual agent 100 may incorporate the context into the actions and execute one or more actions. Then it may generate a statement in case the action desired or the corresponding context are not clearly identified from the explicit input. Subsequently, the virtual agent 100 may output the statement in an audio format, and customize the audio and statement based on a profile of the user that has been stored by the virtual agent 100.

In an implementation, the virtual agent 100 may communicate with one or more external systems to complete actions requested by the user. Such actions may include a transaction of the user. As an example, for a dining business, the virtual agent 100 may communicate with an order system to place the dining order for the user by using his stored financial details. These may include one or more of a stored credit card, debit card or bank account, among others. The order system may include a Point of Sale (POS) system used by the external system to carry out transactions with the user. As an example, the POS system for a dining place such as a restaurant may have all menu items and their prices stored in a database. When the user orders one or more items from the menu, the relevant information may be retrieved from the database to generate a bill for the user. Further, the order may be placed after the user completes the transaction by paying for the ordered items.

The virtual agent 100 may contact external systems to complete any transaction of the user. In case the virtual agent 100 performs a secure transaction, the virtual agent 100 may be required to validate the user it is communicating with. The virtual agent 100 may compare the voice input of the user with an existing voice biometric of the user. Additionally, the virtual agent 100 may validate the phone number used by the user to ensure that the same phone number is associated with the user. As an example, validation may be required in a scenario where the virtual agent 100 may contact an order system to place the dining order for the user, using their stored credit card. The virtual agent 100 may also validate a user in case of one or more secure transactions related to transferring funds, buying plane tickets and making hotel reservation, among others.

In an implementation, the virtual agent 100 may compute a signature for the user's conversation style. The virtual agent 100 may analyse the user's speech using one or more algorithms. Additionally, as an additional verification, the speech analysis may be based on how the user uses frequently occurring words during the communication session with the virtual agent 100. Further, the virtual agent 100 may analyse the user's conversation patterns from one or more sources of the user's text or speech. The sources may include SMS, e-mail and social media platforms, among others, that are used by the user. Further, the virtual agent 100 may keep track of one or more patterns in the sentences that are frequently used by the user in their conversations.

In an implementation, in case there is a difference between the sentence pattern of the user determined from previous conversations, and the sentence pattern of the user in the current conversation, one or more security measures may be implemented by the virtual agent 100. As an example, the virtual agent 100 may determine that the user generally wishes a person by “Hello {Name}” from the user's conversations in their Email and Chat history. In case the user says “hey {Name}” the current communication session, the virtual agent 100 may tighten the security of the system.

In an implementation, the software comprising the virtual agent 100 may be embedded into the software application or the website of the small business. Alternatively, it may be provided as a separate service.

In an implementation, the virtual agent 100 may be configured to execute one or more actions along with a speech dialogue during the communication session with the user. As an example, the user may give the virtual agent 100 verbal feedback such as “This dress is too dark and pricey” when they look at a dress they are browsing. The dialogue module 208 may understand this feedback and convert the feedback to a normalized query which the virtual agent server 104 may understand. In an implementation, a visual semantic embedding may be constructed by using one or more of the item characteristics such as description and pixel information of the image the person is looking at. Further, a normalized sentence may be constructed from the user's verbal utterances.

### Virtual Agent Configured to Handle Customer Service Calls

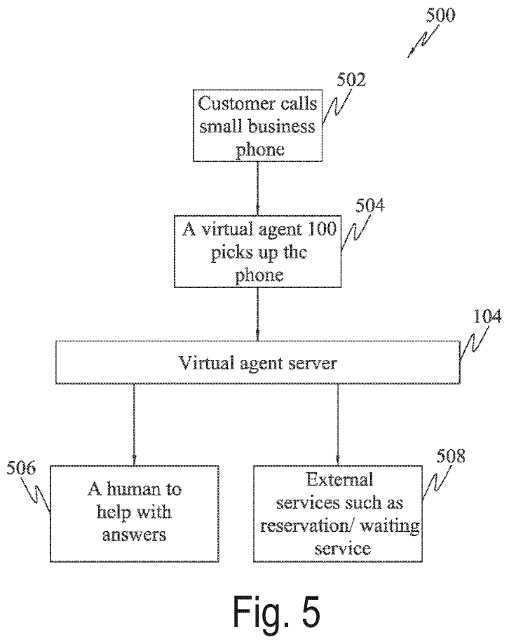

FIG. 5: depicts a diagram illustrating one or more exemplary workflows enabling a virtual agent client 202 (coupled to a virtual agent server 104) to handle customer service calls for a small business, per one or more implementations of the present disclosure. The virtual agent client 202 may answer questions about the business and help to book appointments for the businesses. To answer questions about the business, the virtual agent client 202 may rely on virtual agent server 104.

In an implementation, the virtual agent 100 may act as a virtual customer representative system and receive audio or text input from a user. The user may be identified from the audio or text input based on the conversational characteristics of the user, by comparing them with conversational characteristics of existing users. The virtual agent 100 may use the audio or text input to identify an action desired by the user and identify a context corresponding to the action. Further, it may enable the carrying out of the desired action in case the user is identified and authorized to carry out the desired action. Further, as discussed above, the audio output may be based on context derived from the current communication session as well as any previous communication sessions with the user.

In an implementation, as depicted in FIG. 5, the customer may call the phone of a small business for a product or a service as shown at step 502. The virtual agent 100 connected to that phone may receive the call as shown in step 504. Further, in case an uneasiness is detected in the user's voice as discussed below, the virtual agent server 104 may connect the customer to a human customer representative as depicted at step 506. Alternatively, it may connect the customer to an external service such as a reservation or a waiting service as shown at step 508. As an example, a customer calls a local restaurant and tries to place an order. The call will be picked up a virtual agent 100 who wishes the customer with the business name with a personalized voice. This may be done by routing the business phone number to a call centre operated by virtual agents 100.

The virtual agent 100 may generate audio outputs for the user where the content of the audio output depends on the content of the audio input and on information from the website got by crawling. The characteristics of the audio output may be customized on the identity of the user.

In an implementation, the voice context may also be used to determine an uneasiness score. The virtual agent 100 may evaluate a sense of uneasiness in the user's voice and/or text by processing their speech using the speech context. The virtual agent 100 may also evaluate the sentiment of the user during the communication session to detect a sense of uneasiness in the customer voice and try to connect him to a human to for further assistance in case the uneasiness score of the user crosses an uneasiness threshold. The human customer service representative may be able to further assist the user by clarifying his concerns. As an example, the user may say “I am not satisfied with your response. I want to speak to the manager”. In response, the virtual agent 100 may detect dissatisfaction or uneasiness in the voice input of the user and may ask the user whether they want to speak with a customer service representative or the manager as requested by the user.

In an implementation, the virtual agent 100 may include one or more predictive algorithms or machine learning classifier algorithms. These algorithms may be trained to detect one or more features in the user's voice input such as a difference in the voice amplitude of the current interaction and previous interaction. The algorithms may also be trained on the repetition of same words or repetition of words which are close when spelled out, among others. Further, the virtual agent 100 may use the uneasiness score to determine whether the user is dissatisfied with the virtual agent 100 to generate one or more courses of action. As an example, the user may say “I'm not understanding what you want are saying.” with a different voice amplitude. In this case, the virtual agent 100 may suggest the user to speak with a customer representative.

In an implementation, the voice input may be used to compute an urgency score which may be based on the speech characteristics of the application. The sentiment of the user may correspond to the urgency score. The urgency score of the user for accessing a service may be determined by predictive or machine learning methods using inputs including one or more of rate of speech (words/second), pitch of speech, use of words such as “rush” and “urgent”, among others. As an example, a user may say “I am extremely hungry and want food as soon as possible”. In response, the virtual agent 100 serving a small business may process the user's speech and determine that the user has used one or more keys words and/or tokens such as “extremely hungry” and “as soon as possible”. Further, the virtual agent 100 may talk to the user regarding quickly-made burgers available in the restaurant. The virtual agent 100 may also stress that it is immediately available for pickup, noting that the user wants to eat food urgently.

In an implementation, the urgency score may be used to determine or alter the sequence of actions executed by the virtual agent client 202. An action or suggestion which is urgent for the user may be executed before other actions. In an example, this urgency signal may be used to alter the ordering of the items in the spoken dialogue.

In an implementation, the visual semantic embedding may be constructed using a convolutional neural network. The convolutional neural network may be trained with one or more annotated images from Flickr and ecommerce items from the retailer. The virtual agent server 104 may take the visual semantic embedding, price filters from the client code and may search the catalogue to generate items that may match the user's interest. Further, the results may be displayed to the user and the virtual agent 100 may receive more feedback from the user. This feedback may then be used to suggest further items, until the user completes the transaction flow either through a purchase or by explicitly closing the application. Thus, the virtual agent 100 may act as a salesman for an ecommerce store to increase conversion in the software application or website.

In an implementation, a normalized sentence may be constructed using manual rules. As an example, in case the user says “this dress is too pricey”, the virtual agent 100 may convert the sentence to a query on the backend. The query may include information regarding the cost of the product. Further, the virtual agent 100 may collect further information such as current price information and applicable discounts, if any. In case discounts are available, the virtual agent 100 may decrease the price of the item by “X” $, where “X” may correspond to a discount. Subsequently, the virtual agent 100 may communicate the decreased or discounted price to the user.

In an implementation, the virtual agent 100 may be able to perform multiple actions for a user during a single conversation. As an example, in case the user says “Can you place an order for my regular shoes and socks”, the dialogue module 208 may send multiple actions to the context generation module 210. The actions may include placing an order for shoes and placing an order for socks. Further, the context generation module 210 may generate relevant responses for the user and the virtual agent client 202 on the browser may initiate the requested actions for the user.

In another implementation, the virtual agent server 104 may receive information regarding web-services for checkout through manual configuration or web service discovery mechanisms. Subsequently, the context generation module 210 may initiate one or more actions on the user's behalf. Further, it may communicate one or more notifications to the user with a customised message to acknowledge the performed actions. As an example, the virtual agent 100 may place an order for shoes and socks for the user as described in the example above. Subsequently, the virtual agent may communicate a notification message to the user which may state “I have ordered shoes and socks for you. You can expect them to be delivered to your home tomorrow.”

In an implementation, there may be a software application wherein a user may place a phone call to an organization to purchase a product or a service. Such organizations may include restaurants, supermarkets, dry-cleaners, among other organizations that may be contacted by the user. As an example, a user may call a local restaurant to place an order. The call may be picked up a virtual agent client 202 who may greet the user in a personalized voice with the business name. Further, the virtual agent 100 may provide any assistance needed by the user to complete their request. This may be done by routing the business phone number to a call centre operated by one or more virtual agents 100.

In an implementation, the virtual agent server 104 may rely on offline processes to collect knowledge about the business. The offline component of the virtual agent 100 may crawl one or more relevant small business website to collect data about the offerings of the business. This data may be stored in one or more databases. Further, the virtual agent server 104 may query the data. Subsequently, the virtual agent server 104 may construct one or more natural responses for the user.

In an implementation, the offline process may use one or more techniques such as pattern matching rules, entity name recognition techniques and/or deep learning techniques to extract information about the business and its offerings. Users may also manually add information about the business into the database. The offline component may also convert previous user service call sessions to textual question and answer sessions to extract further information about the businesses. This may be achieved by using regular expression parsing and entity name recognition techniques.

### Example Implementation

Referring to FIG. 7, the virtual agent client 202 and virtual agent server 104 may be integrated with a video streaming mobile application 700. At step 702, a user of the application 700 provides an audio input. The audio input may be provided by speaking into the smartphone. An example of the audio input may be “can you show me action movies”. The audio input provided by the user is received by the virtual agent client 202, which is residing on the user's smartphone and integrated with the application 700. It may be appreciated that the input provided by the user is not in a structured format, rather the input is in a natural language format. The virtual agent client 202 sends the user's input to the virtual agent server 104 at step 704. The input may be communicated to the server 104 is the audio format. Alternatively, the client 202 may convert the input into text format, and the text in natural language format may be communicated to the server 104. The server 104 processes the input to determine the intent of the user and identifies the action available in the application 700 that, correlates with the intent. As an example, the phrase “can you show me” is processed to identify that the intent of the user by said phrase is to search. The server 104 also identifies that for a search intent, the corresponding action on the application is to conduct a search action by providing a search query and activating the search button. The server 104 identifies that the search string for the intent is “action movies”. It may be noted that, in case the server 104 identifies that the action desired is search, but the string to be used is absent in the input, then the server 104, via the client 102, may probe the user to provide a voice (preferably) input with the string. The server 104, at step 706, sends instruction to the client 202 to activate the search button after populating the search box with “action movies”. The client 202, at step 708, populates the search box with “action movies”. It may be noted that, although in this example, the box that is visible on the user interface is shown to be populated with the search string, the client 202 may alternatively populate the search string at the backend associated with the search box. Once the search string is populated, the client 202 activates the search button, at step 710. The application 700 may bring up results as a consequence of these actions. The client 202, at step 712, may enable generation of an output (preferably voice) by the smartphone. The output may be, in this example, “showing action movies”.

### Virtual Agent for a Brick and Mortar Store

As discussed in the background earlier, while customers experience problems in their online engagement, brick and mortar stores have their own share of problems. In a brick and mortar store, products are stored in racks spread across the floor of the store which makes it difficult to locate products in the store. Locating products may require extra effort and time spent by the customers or store assistants, which results in inefficient utilization of time and resources.

A user may go to a retail store and have a question about the exact location of an item. The user may open a software application or browser on their phone which includes a virtual agent 100 to find the location and route. The user may ask the virtual agent 100 “Where are the apples?”. The virtual agent 100 may receive and process the customer's question to determine and share the required aisle information. Further, the virtual agent 100 may guide the user to the item's location using one or more route finding algorithms including Dijkstra's algorithm.

In an implementation, the virtual agent 100 may further include an image capturing device like a camera to take one or more images of items in a retail store. The virtual agent 100 may further include a processor to associate a set of location coordinates to one or more of the images that are captured by the camera. Further, it may associate at least one tag with that image, and receive an input from a user who is requesting for the location of an item. The processor may specify the location of the item within the retail store based on the associated tag and the set of coordinates associated with the captured images.

In an implementation, the camera may be mounted on a land vehicle like a robot or an aerial vehicle like a quadcopter or drone. The vehicle may travel around the retail store while the camera captures images of the items in the store. The vehicle may be configured to traverse at preconfigured times, or upon initiation by a user.

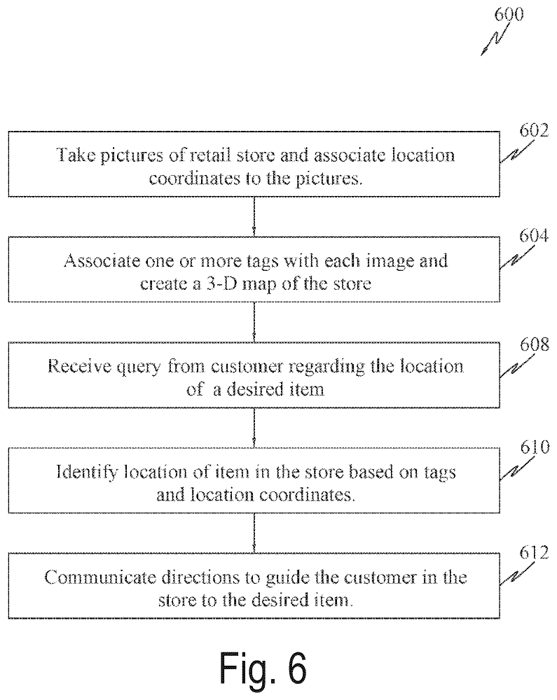

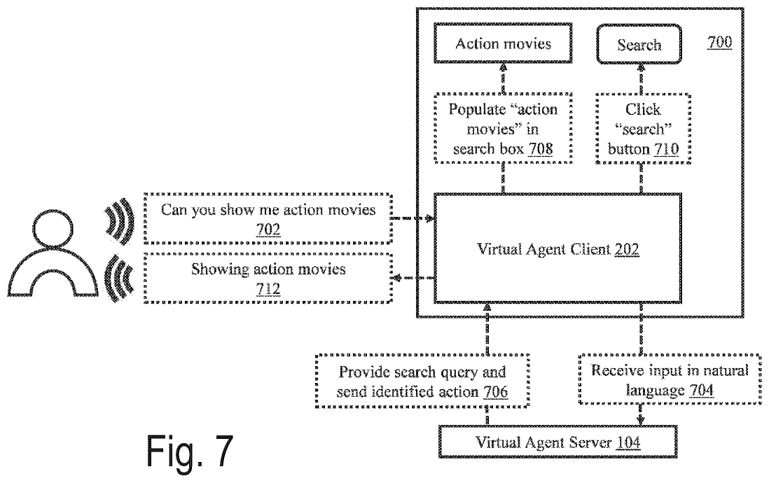

FIG. 6: depicts a flowchart 600 illustrating a virtual agent 100 helping a user in finding a physical route, in accordance with an implementation. In step 602, the camera may take one or pictures of items in the retail store. Further, the virtual agent 100 may associate one or more location coordinates to each of the pictures taken by the camera. The virtual agent 100 may associate each picture with one or more tags relevant to the picture. Further, the virtual agent server 100 may create a three-dimensional map or representation of the store as shown at step 604. Subsequently, the virtual agent 100 may communicate with a user and receive a query from the user regarding the location of one or more items desired by the user as shown at step 606. The virtual agent may use the associated tags and location coordinates to determine the position of the user's desired item as shown in step 608. Further, the virtual agent 100 may communicate with the user to provide directions to the desired item, as shown at step 610.

In an implementation, to give the user the location of the item, the virtual agent 100 may create a 3-dimensional representation of the retail store, and a map of x, y, z coordinates for each item, using an offline program to process the captured images. This may be done by an autonomous or semi manual quadcopter with a camera mounted on it. The quadcopter may take images of scanned items as it flies through the retail store, recording a set of three coordinates, namely, x, y, z coordinates of the positions of the item. The three coordinates may also be provided with respect to the layout of the retail store. The recorded image may be tagged with a set of coordinates based on the coordinates of the camera at the time of capturing the image. After recording the images and their x, y, z coordinates, a clustering algorithm such as k-means may be run on the characteristics of the images to group them and to generate a representative image position for the group. The quadcopter may run across the retail store multiple times to ensure maximum coverage of the inventory and increase accuracy of the positions for the items. The items in an image may be identified by the processor which may add more than one set of coordinates to a captured image based on the location of the identified items within each captured image.

In an implementation, the processor may identify items in a captured image and may add one or more tags to the image based on the identified items. The processor may use one or more images of items already stored in a database for comparison while identifying one or more items. The database may include one or more tags for one or more items in the retail store. One or more textual annotations for the images may be added by manual input or a combination of machine learning and predictive algorithms after determining the positions of the images. A combination of convolutional neural networks and recurrent neural networks may be used to generate a generic verbal description of the items in an algorithm implementation. The models may be trained on a retail data set comprising images and their textual descriptions collected through crowd sourcing methods to increase the accuracy of these models. The retailers generally group items in certain locations. The offline program after capturing the items may construct a hierarchy grouping for the items. The data for offline grouping may be generated manually or the information may be gathered by querying databases. As an example, let us say a retail salesman starts the quadcopter to scan the images every 2 days. The quadcopter scans the images of the items, aisle numbers and uses the image to textual algorithms to come up with a representation of items and their x, y, z coordinates in the store. The images and/or annotations may be used to query the retailer catalogue using image match and text match methods to get more metadata for the item.

In an implementation, this metadata may be parsed to extract the broader category hierarchy of the item and other metadata information such as synonyms for the item. The broader category metadata may be added as a data element which may be, queried by the virtual agent 100 to answer queries about the item.

In an implementation, the processor may specify the location of an item with respect to a reference location in the store. The reference locations may include one or more static locations such as a door, an entry, exit, or one or more dynamic locations such as a temporary shelf or a current location of the user. As an example, after generating the position map for each of the retail item, the virtual agent 100 of the retail store may welcome a customer and ask them what they require. The virtual agent 100 may help the customer by answering one or more questions related to price, brand and availability of an item, among others, by looking up the retail stores database. In case the customer asks the virtual agent 100 to take them to the exact location where they may find a certain item, for instance “strawberry jam”, the virtual agent 100 may use the three-dimensional Map of the items and descriptions that it constructed using the quadcopter, to find the location of the item and may guide the customer to the item's location from the customer's current position. It is to be noted that the three-dimensional Map of item and location information may be manually added into the database.

In an implementation, ultra-wideband technology may be used to get centimetre resolution for recording positions of the items and position of the shopper, to increase the accuracy of the location systems. The three-dimensional model of aisles and items may then be used to guide the customer by using a route-finding algorithm.

The present disclosure takes into consideration the preferences of users and generates suggestions which may be suitable to the user(s). Additionally, the system helps in suggestion and selection of products on a website or software application. Further, the system helps in speaking with customers and executing their orders. The system also helps customers to locate items in a brick-and-mortar store. Thus, the present disclosure as discussed in this document with respect to different embodiments will be advantageous at least in optimizing the process of selection of products and execution of actions of a user. Further, it is advantageous in providing better user experience and decreasing time and effort required by users. Additional advantages not listed may be understood by a person skilled in the art considering the embodiments disclosed above.

The present invention relates to conversational AI systems, and more particularly to computer-implemented virtual agent platforms (such as e-commerce chat or voice agents) that assess user's emotional state. Specifically, it relates to a multimodal sentiment engine that combines facial-expression analysis, eye-gaze tracking, speech prosody, and user interaction patterns to compute a unified user sentiment or “unhappiness” score and adapt the agent's behavior.

In an exemplary embodiment, the invention is a system (or method) in a virtual agent context that captures and fuses multimodal user data to detect sentiment. As disclosed in the parent patent, the virtual agent can process implicit inputs such as the user's facial expressions, voice and speech cues, visual gaze or navigation patterns to determine whether the user is becoming unhappy. In the improvement, a sentiment analysis engine combines these inputs to compute an unhappiness score. For example, the engine may use a predictive or machine-learning model (such as a trained linear regression or neural network) that takes features like duration the user looks at an item, navigation patterns, speech prosody, and vision context to generate a unified score. If the unhappiness score crosses a threshold (signifying potential dissatisfaction), the system alters its behavior. In practice, this can mean the agent suggests alternative items (e.g. offering different sizes, prices, colors or brands) or shifts the dialogue strategy to clarify the user's intent. For instance, if a user says “show me red toy cars” but appears dissatisfied with the results, the agent might proactively offer variations (e.g. “Would you like blue or green toy cars instead?”) or prompt a human handoff. These alternative offers and dialogue shifts are tailored to reduce the user's unhappiness, as taught by the parent specification.

In one implementation, the Sentiment Engine includes machine-learning models. For example, a linear regression model (trained on past user sessions or crowdsourced data) may take features such as time spent viewing an item, gaze movement patterns, speech energy, and sentiment keywords to output a numeric unhappiness score. Alternatively, a convolutional neural network or a decision tree could process image-derived features and prosody features. The key is that the system is configured “to generate a score for the user's unhappiness called an unhappiness score”. This may run locally in the browser or on the virtual agent server, as disclosed.

Once computed, the unhappiness score is evaluated. If the score exceeds a certain threshold, the agent takes remedial steps. As taught in the parent patent, the agent then “may suggest or carry out one or more actions to reduce the unhappiness of the user”. For instance, if the user is unhappy with a displayed product, the agent might propose different products: “different sizes, prices or brands related to that item”. These suggestions could include alternative colors, styles or price options (e.g. “price, shape, size, color, brand or manufacturer”) to cross-sell or retain the user. In another scenario, if the sentiment engine detects confusion (say, uncertain facial cues or lower speech tone), the agent may automatically switch to a simpler dialogue or offer help: for example, “Would you like assistance from a customer representative?” This aligns with the disclosure that the agent can adjust its “provisions” based on user unhappiness. All these features are drawn from the disclosure of the parent patent specification. The improvement lies in explicitly combining multiple modalities (face, gaze, prosody, behavior) into a single sentiment score and routing the outcome into the agent's decision logic. The parameters, thresholds, and ML algorithms can be configured as in the parent disclosure. For example, as the parent patent specification notes, the unhappiness score may be computed by formula or ML (e.g. Linear Regression) trained on past interactions. The system is not limited to specific algorithms, but any technique that uses the disclosed features (facial cues, voice cues, navigation patterns) is within scope.

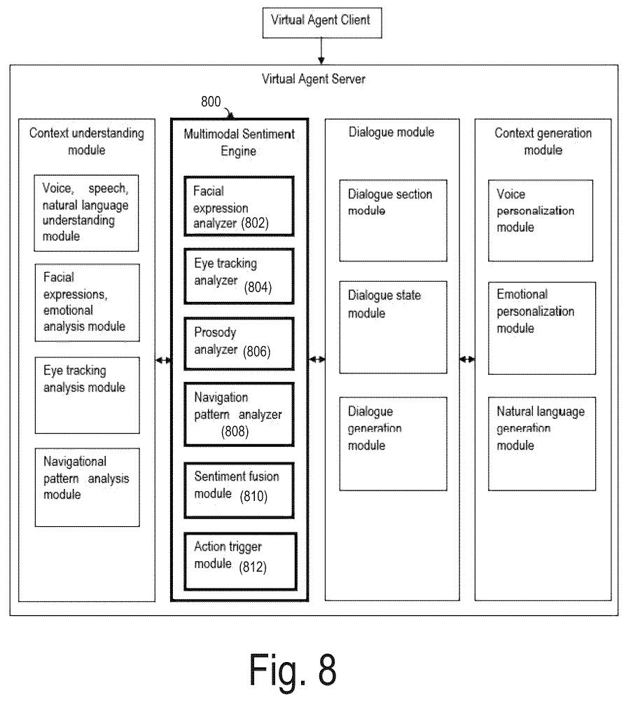

In FIG. 8, an example virtual agent system with the multimodal sentiment engine disclosed by the present invention is illustrated in the form of a block diagram. A user's client device (with camera and microphone) provides inputs to a virtual agent server. The server includes: an Input Module capturing camera images (facial expressions, eye gaze) and microphone audio; a Navigation Tracker recording on-screen interactions; a Sentiment Engine that processes these inputs using predictive code to compute an unhappiness score; and an Action Selector that chooses agent actions based on the score.

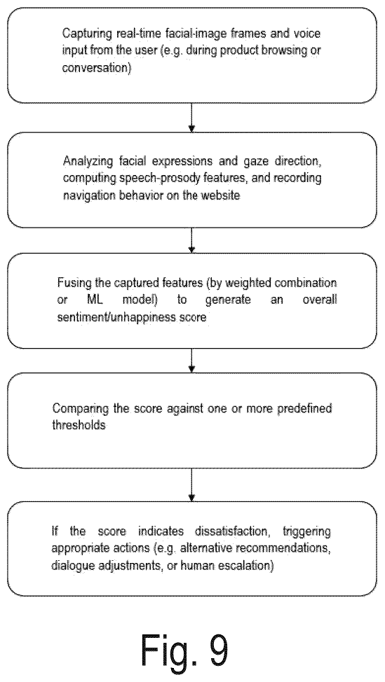

FIG. 9: provides a flow chart of the sentiment-analysis process of the present invention wherein the system steps include: (a) capturing real-time facial-image frames and voice input from the user (e.g. during product browsing or conversation); (b) analyzing facial expressions and gaze direction, computing speech-prosody features, and recording navigation behavior on the website; (c) fusing these features (by weighted combination or ML model) to generate an overall sentiment/unhappiness score; (d) comparing the score against one or more predefined thresholds; and (e) if the score indicates dissatisfaction, triggering appropriate actions (e.g. alternative recommendations, dialogue adjustments, or human escalation).

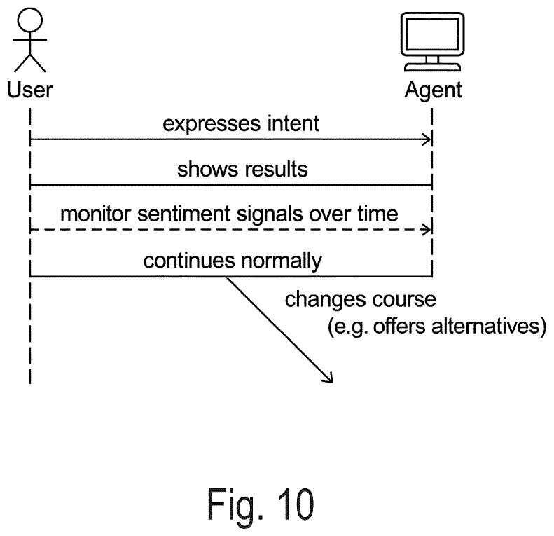

FIG. 10: depicts a sequence diagram of user-agent interaction: user expresses intent, agent shows results, monitors sentiment signals over time, then either continues normally or changes course (for example, offering alternatives).

In the preferred embodiment, referring to FIG. 9 of the parent patent specification, context understanding module feeds into dialogue module. The Multimodal Sentiment Engine 800 of the present invention intercepts these signals. The said multimodal sentiment engine 800 for the virtual agent system comprises: (a) a facial expression analyzer 802 configured to classify facial imagery into emotion vectors; (b) an eye tracking analyzer 804 configured to output gaze fixation vectors; (c) a prosody analyzer 806 configured to derive acoustic feature vectors from user speech; (d) a navigation pattern analyzer 808 configured to compute interaction context vectors from user application behavior; (e) a sentiment fusion module 810 operable to combine vectors from (a) to (d) and compute a continuous unhappiness score; and (f) an action trigger module 812 configured to modify dialogue flow by (i) selecting alternative content or (ii) initiating a human agent escalation when the unhappiness score exceeds a configurable threshold.

The Facial Expression Analyzer 802 is a Convolutional Neural Network (CNN) classifier that outputs seven emotion probability vector from webcam frames. The Eye Tracking Analyzer 804 is a JavaScript based gaze tracker yielding fixation coordinates and dwell time. The Prosody Analyzer 86 is an audio frontend that extracts Mel-frequency Cepstral Coefficients (MFCC), pitch, energy; Bidirectional Long Short-Term Memory (Bi-LSTM) outputs arousal/valence pair. The Navigation Pattern Analyzer 808 is an in browser tracker that computes click entropy, back tracks, idle gaps.

The Sentiment Fusion Module 810 implements either: (i) manually weighted linear regression (weights w₁-w₄) or (ii) MLP (3 layers, ReLU, softmax) trained on 50 k labelled sessions. Output U is continuous. The action trigger module 312 configured to modify dialogue flow whereby:
If U≥T₁ (e.g. 0.5)→dialogue module requests alternative offer workflow.
If U≥T₂ (e.g. 0.8 for ≥3 s)→SIP/WebRTC hand-off to human agent. Both thresholds are configurable via admin panel.
Model Maintenance: Log feature tensors, U, chosen actions, post interaction satisfaction label; nightly retrain fusion model to refine weights.
Edge/Server Deployment: Analyzers may execute client side via Web Assembly or server side containers; fusion model selectable based on latency budget.
Privacy Safeguards: Raw webcam frames discarded after feature extraction; speech samples anonymized; navigation logs hashed.

In the preferred embodiment of the present invention, the sentiment fusion module 810 implements a machine learning network trained on historical labelled sessions and furthermore, the sentiment fusion module is selectable between a linear regression model and a multilayer perceptron model.

In the preferred embodiment of the present invention, the facial expression analyzer 802 discards frames whose classifier confidence is below 0.5.

In the preferred embodiment of the present invention, the prosody analyzer 806 detects uneasiness by identifying a pitch increase exceeding 15% over baseline.

In the preferred embodiment of the present invention, the action trigger module 812 escalates the session via SIP or WebRTC when the unhappiness score exceeds 0.8 for at least three continuous seconds.

In the preferred embodiment of the present invention, feature tensors and actions are logged for offline model retraining.

What has been described and illustrated herein is a preferred embodiment of the invention along with some of its components. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

The basic aspect of the present invention is to enable a virtual agent system to assist and guide a customer in a brick-and-mortar store to efficiently locate items without having to waste time and resources searching for a particular item/s. It is the primary aspect of the present invention to provide an improvement or modification by way of integrating a visual mapping subsystem that generates a three-dimensional (3-D) coordinate map of items within a brick-and-mortar retail environment to the virtual agent system of patent no. 312437 so as to enable it to guide shoppers accurately to product locations.

The present invention is a three-dimensional visual mapping system for instore virtual agent navigation, for use with the virtual agent platform of Indian Patent No. 312437, the system comprising:
(a) an image capture device mounted on a mobile platform or client device including at least one of: a cart-mounted smartphone, a handheld smartphone, a head-mounted display (HMD) comprising smart-glasses, a ground robot, or a drone, configured to acquire image frames of shelves and items while traversing aisles;
(b) a positioning engine configured to determine, for each captured frame, a set of three-dimensional coordinates [symbol] x,y,z [symbol] relative to a store reference frame using one or more of: ultra-wideband (UWB) anchors, Bluetooth Low Energy beacons, Wi-Fi Round-Trip-Time, visual-inertial SLAM using device camera/IMU, depth/LiDAR, or ceiling camera localization;
(c) a map generation module comprising an edge server and/or cloud service configured to associate the coordinates with frames, extract visual features indicative of individual items, and cluster frames into item nodes on the basis of spatial proximity using a clustering algorithm selected from K-means, DBSCAN, or agglomerative clustering, and to persist a 3-D item location map in a database; and
(d) a navigation module integrated with the virtual agent platform and a user client (170) configured, upon receiving a natural-language query or pick-list, to resolve the query to a catalogue identifier, retrieve a corresponding item node, compute a navigation path from a user's current coordinates to the item node using a shortest-path algorithm selected from Dijkstra, A*, or Floyd-Warshall, subject to aisle direction, staff-only and accessibility constraints, and render turn-by-turn guidance via augmented reality overlays on a smartphone or HMD, and/or via spoken/haptic instructions.

In an exemplary embodiment of the present invention, a camera module (RGB, ≥1080 p) is mounted on an autonomous vehicle (1120) which can be a ground robot or a drone. UWB anchors (1130(a-n)) are fixed to ceiling grid to furnish centimeter level indoor positioning. A positioning engine streams [symbol] x,y,z [symbol] coordinates to the vehicle (1120). the positioning engine employs ultra-wide band anchors affixed to the store infrastructure to achieve centimeter level coordinate accuracy.

Capture devices: The image capture device (RGB and/or depth) may be (i) phone-mounted on a shopping cart, (ii) a handheld smartphone, (iii) a head-mounted display (HMD) (smart-glasses), (iv) a ground robot, or (v) a drone.

Positioning. The positioning engine provides [symbol] x,y,z [symbol] via one or more of UWB anchors, BLE beacon trilateration, Wi-Fi RTT, visualinertial SLAM (device camera+IMU), LiDAR depth, or ceiling cameras. Coordinates are embedded in frame metadata (e.g., EXIF) or stored as parallel tuples.

Embodiment with wearable AR such as Smart-Glasses/Meta glasses: In another exemplary embodiment of the present invention, guidance renders on a head-mounted display (HMD) such as smart glasses. The device uses on-board camera+IMU to maintain pose and align AR arrows/labels to shelves using visual-inertial SLAM, cross-calibrated to store coordinates from the persistent map. Voice input/output is supported; haptic feedback may be provided via watch/phone. (Examples include eyewear-based devices widely available in commerce.)

The present invention also discloses a method for generating a 3-D visual map of a retail store inventory, the said method comprising the steps of: image capture wherein the vehicle (1120) follows a pre-configured waypoint script each after hours scan cycle wherein frames are captured every 0.5 meter; coordinate tagging wherein for each frame, the positioning engine (1140) supplies absolute coordinates [symbol] x,y,z [symbol] which are embedded in frame metadata (e.g., EX; feature extraction wherein the edge server (1150) detects SKU facings within each frame; clustering wherein K-means, namely k predetermined per aisle, groups feature/coordinate tuples into item nodes Nᵢ namely centroids, the said centroids then being stored in the store map database (1160); indexing wherein each node is annotated with text labels derived from shelf tags or retailer catalogue records. In an exemplary embodiment of the present invention, the SKU facings within each frame detected by the edge server (1150) are ORB or SIFT key points.

The present invention further discloses a method of navigation of the user to the location of the item/s desired by the user, the said method comprising the steps of: intake of query wherein the user inputs a query to the user mobile client (1170); entity match wherein the virtual agent system resolves the keyword in the user query to the corresponding catalogue ID; map lookup wherein the store map database returns the corresponding node Ni with the corresponding coordinates [symbol] xx, yy, zz [symbol] ; computing path wherein the shortest-path algorithm (such as Dijkstra, K-means) runs on node graph such that the result is ordered waypoints (W1 . . . Wk); guidance wherein the user mobile client (1170) renders arrows on AR overlay and provides spoken instructions.

The disclosed method of navigation of the user to the location of the item/s desired is multi-stop, accessibility-aware, and crowd-aware routing. For a shopping list or associate pick-list, the system computes a route that minimizes total cost across N targets (distance, aisle direction), and reorders when stock/out-of-stock or crowding signals are received. Accessibility constraints (ramps/elevators/avoid stairs) and staff-only routes are enforced via path costs and edge masks.

### An Example Implementation of the Present Invention is as Follows

The present improvement to the invention claimed by the parent patent no. 312437 achieves the objectives set out herein vide an autonomous or semi-autonomous vehicle (e.g., a quadcopter drone) that traverses store aisles while a camera captures shelf images. Each image frame is tagged with location coordinates obtained from an ultra-wide band (UWB) anchor grid or other indoor positioning reference as disclosed in paragraph 106 in the complete specification of the parent patent no. 312437. Offline clustering (e.g., k means) aggregates frames into item level nodes. The resulting dataset forms a 3-D point cloud that persists in a store map database. During operation, the virtual agent receives a user query (e.g. —Find strawberry jam), performs entity lookup to obtain a corresponding map node, calculates a shortest path from the user's live coordinates to that node, and guides the user visually and/or verbally along the route as disclosed in the parent patent document in paragraphs 101103.

A user inputs the query—Where is the strawberry jam? either by text or audio to the virtual agent vide the user mobile client (1170). The virtual agent system, through its natural language understanding, resolves the keyword—strawberry jam in the user query to the corresponding catalogue ID, i.e., 58-A. The store map database (1160) then returns node N5 which corresponds to the jam shelf with the corresponding coordinates [symbol] x2,y3,z1 [symbol] . The virtual agent system then computes the shortest path from the user's live coordinates to that node using an algorithm such as Dijkstra which runs on node graph and results in ordered waypoints (W1 . . . Wk) and finally guides the user visually and/or verbally along the route, for example, —Turn left at the dairy aisle . . . . The present improvement disclosed implements exactly this logic.

The three-dimensional visual mapping system disclosed herein is maintained periodically wherein nightly scans refresh coordinates; if an item centroid shifts >0.3 m, the map is updated, and old paths are invalidated.

The same subsystem supports warehouses/dark stores, airports, hospitals/campuses, and big-box layouts. For associate workflows, pick paths respect backroom nodes, staff-only corridors, and trigger inventory updates upon node visit.

Privacy, maintenance, and fallback of the system disclosed herein:
Maintenance: Periodic scans (e.g., nightly) refresh coordinates; if an item centroid drifts >0.3 m, node coordinates and routes update, invalidating stale paths.
Privacy: Feature extraction occurs locally/at edge; raw frames are purged post-extraction; anchor IDs are hashed; only derived features and centroids persist in the map store.
Fallback: In absence of anchors, vision-only SLAM maintains sufficient pose for routing overlays at bay-level resolution.

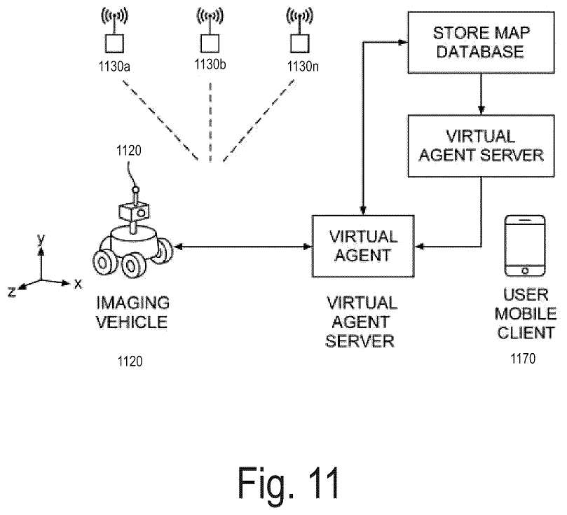

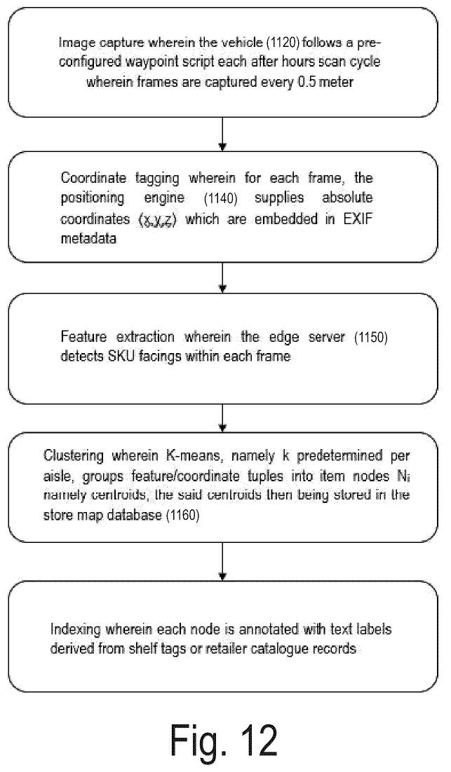

FIG. 11 visually maps out how the Imaging Vehicle (1120), Ultra-10 Wide Band Anchors (1130(a-n)), Store Map Database (1160), Virtual Agent Server, and User Mobile Client (1170) interact to deliver real-time item localization and augmented reality guidance.

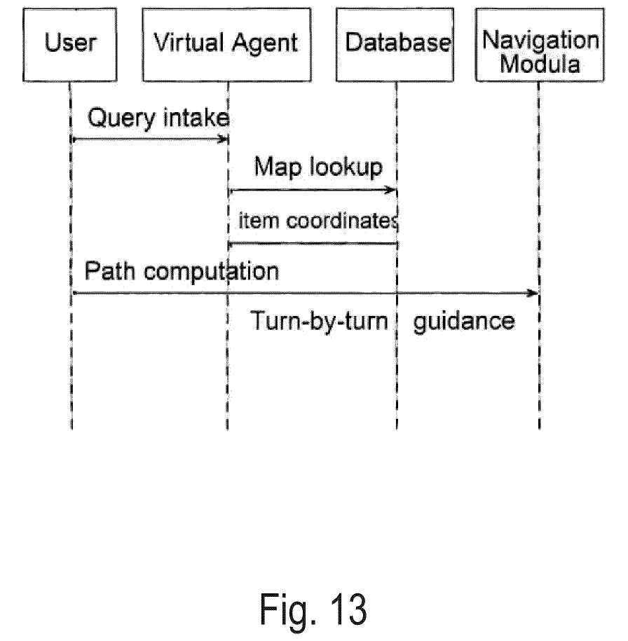

FIG. 13 a sequence diagram for the user routing flow in the instore virtual agent navigation system wherein the User Mobile Client (1170) sends a query, the Virtual Agent Server performs map lookup and retrieves item coordinates from the Store Map Database (160), computes optimal path, and sends turn-by-turn guidance back to the user.

The present invention augments the virtual agent system of Indian Patent 312437. The invention ensures efficient guidance of the user in a brick-and-mortar store thereby eliminating extra effort or time required by the user in locating items, ultimately improving service quality.

What has been described and illustrated herein is a preferred embodiment of the invention along with some of its components. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

The present invention is directed to an improvement or modification of the invention claimed in Indian patent application numbered 201644039413 dated 18 Nov. 2016 with priority date 18 Nov. 2015, titled Systems and Methods for Virtual Agents to Help Customers and Businesses and patent number 312437. Specifically, it relates to an Urgency/Uneasiness Scoring Engine (1400) that augments the virtual agent system claimed by the parent patent by detecting user urgency or frustration (uneasiness) during an interaction and appropriately prioritizing or escalating the conversation. It builds on the parent patent's virtual agent platform by adding modules to score urgency from speech cues and to transfer difficult cases to human operators.

The present invention relates to conversational AI systems, and more particularly to computer-implemented virtual agent platforms (such as e-commerce chat or voice agents) that assess a user's emotional state.

The present invention analyzes user speech in real time to detect urgency. A speech processing module extracts features (such as words per second, vocal pitch, and presence of keywords like —urgent, —rush, or —please hurry) from the user's voice; a predictive/machine-learning logic computes an urgency score from these features (e.g. using models trained on past dialogue data); concurrently or alternatively, the system computes an uneasiness score based on sentiment analysis of the conversation (detecting dissatisfaction in tone or wording); and, these scores are evaluated against configurable thresholds. As taught in the parent specification, the virtual agent (100) may evaluate the sentiment of the user during the communication session to detect a sense of uneasiness and may connect the user to a human if the uneasiness crosses an uneasiness threshold. In accordance with this, the improvement implements a decision logic: if the urgency or uneasiness score is above the threshold, the agent triggers a human escalation. For example, if a user says, —I'm not satisfied with your response, I want to speak to the manager and their vocal tone indicates frustration, the agent will immediately offer to connect them to a human operator.

Even if an explicit request to speak to a manager is not made, high urgency still affects action planning: the agent may reorder actions so that urgent items are prioritized. For instance, if a restaurant-ordering user urgently says, —I need food ASAP, the agent (as in the parent example) notices keywords like —as soon as possible and offers the next available quick items (e.g. burgers ready for immediate pickup). The combination of urgency scoring and escalation is configurable. The thresholds for escalation and the particular responses (connecting a call, highlighting urgent options, etc.) can be set by the service. The parent patent's mention of urgency scoring and human handoff is thus fully realized here.

An example implementation of the present invention is as follows: A user speaks to the virtual agent over a voice interface. An Analysis Module comprising the Behavioral Feature Extractor (1402) and Lexical Sentiment Analyzer (1404) continuously monitors the incoming speech. It measures metrics like words-per-second (rate of speech), changes in pitch, and looks for urgency keywords (—urgent, —as soon as possible, —rush). For example, if the user says, —I'm extremely hungry and want food as soon as possible, the module will detect high energy in the keywords—hungry and as soon as possible. The extracted features are then fed into a Scoring Model (1406) which may employ a machine-learning classifier or regression (as in the parent text) to output a numeric urgency score reflecting how urgent the request is. The urgency score can be updated dynamically as the user continues to speak. The parent specification suggests that—the urgency score of the user for accessing a 15 service may be determined by predictive or machine learning methods using inputs including . . . rate of speech (words/second), pitch of speech, use of words such as _rush′ and _urgent′. This improvement implements exactly this logic.

Simultaneously, an Uneasiness Detector may run (either the same module or a separate process). This detects user frustration or dissatisfaction. For example, if the user's tone becomes agitated or the user uses negative language, (—I'm not happy with this), the system computes an uneasiness score. As in the parent disclosure: —the virtual agent (100) may evaluate the sentiment of the user during the communication session to detect a sense of uneasiness in the customer voice.

Both scores are compared to configurable thresholds. If the urgency score or uneasiness score crosses its threshold, the Escalation Controller (1408) intervenes. For example, when uneasiness is high: —the virtual agent (100) may also evaluate the sentiment of the user . . . and try to connect him to a human . . . in case the uneasiness score of the user crosses an uneasiness threshold. Practically, the system may then announce: —It sounds like you're having trouble. I will connect you to a human representative. This matches the disclosure that if the user says —I am not satisfied with your response. I want to speak to the manager, the agent will recognize this and escalate.

Even without explicit requests, the system handles urgency. If only the urgency score is high (e.g. user says —I need this quickly), the agent may reprioritize actions rather than directly escalate. As the parent explains, an urgency signal can—alter the sequence of actions executed and—be used to alter the ordering of the items in the spoken dialogue. For example, in a food-ordering context, detecting—urgently leads the agent to first suggest the quickest available meals (burgers ready for immediate pickup). This ensures urgent needs are addressed first.

All machine-learning models and thresholds are set up consistent with the parent patent's disclosure. For instance, training data can come from the parent's recorded user interactions. Configuration (e.g. threshold values for escalation) is adjustable by administrators. The architecture can follow the parent system's client-server design (the agent code can be in browser or on a server), with the new modules integrated into the agent's 20 dialogue engine. In essence, this addition endows the agent with situational awareness: it notices when the user is upset or in a hurry and responds appropriately, using the techniques already suggested in the parent specification.

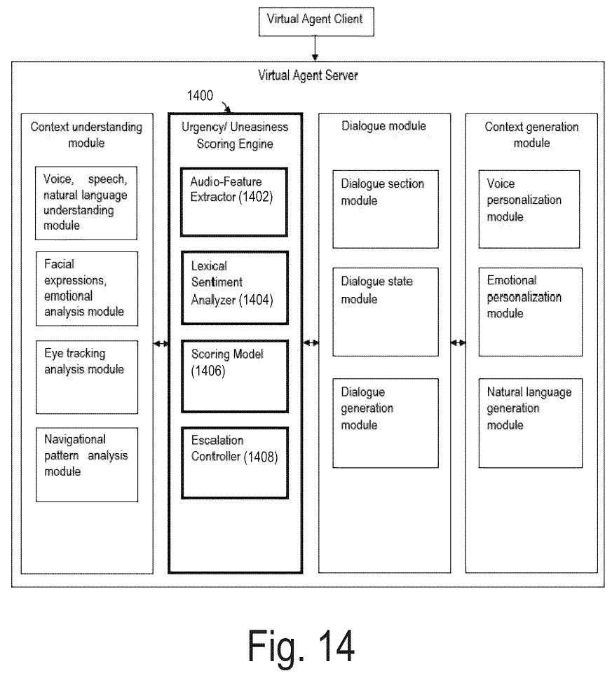

In FIG. 14, an example virtual agent system with the Urgency/Uneasiness Scoring Engine (1400) disclosed by the present invention is illustrated in the form of a block diagram. A user's client device (with microphone) provides speech inputs to a virtual agent (100). The server includes: a Audio-Feature Extractor (1402) extracting speech rate, pitch, keywords, etc.; a Lexical Sentiment Analyzer (1404) which determines polarity and frustration indicators; a Scoring Model (1406) that processes the inputs of the Audio-Feature Extractor (1402) and the Lexical Sentiment Analyzer (1404) using predictive code to compute an urgency/uneasiness score; and an Escalation Controller (1408) that, if the score exceeds a set threshold, transfers control to a human representative.

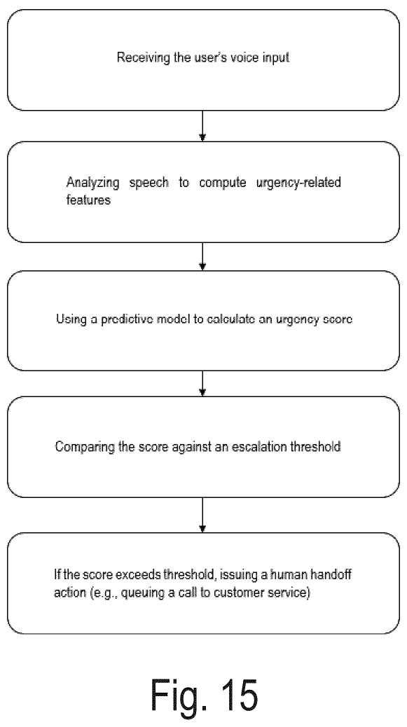

FIG. 15 provides a flow chart of the urgency scoring process of the present invention wherein the system steps include: (a) receiving the user's voice input; (b) analyzing speech to compute urgency-related features; (c) using a predictive model to calculate an urgency score; (d) comparing the score against an escalation threshold; and, (e) if exceeded, issuing a human handoff action (e.g., queuing a call to customer service).

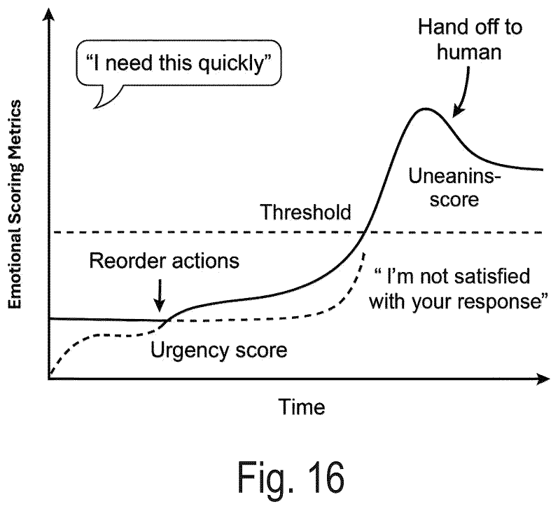

FIG. 16 depicts a timeline showing how rising urgency and uneasiness scores dynamically shape agent behavior. It demonstrates how the system first reprioritizes actions due to escalating urgency, then pivots to human escalation as uneasiness crosses the threshold.

In the preferred embodiment, referring to FIG. 14 of the parent patent specification, context understanding module feeds into dialogue module. The Urgency/Uneasiness Scoring Engine (1400) of the present invention intercepts these signals. The said Urgency/Uneasiness Scoring Engine (1400) for the virtual agent system of Indian Patent No. 312437 comprises: a Behavioral Feature Extractor (1402) extracting speech rate, pitch, keywords, etc.; a Lexical Sentiment Analyzer (1404) which determines polarity and frustration indicators; a Scoring Model (1406) which is fed inputs by the Behavioral Feature Extractor (1402) and Lexical Sentiment Analyzer (1404); and an Escalation Controller (1408) which compares the scores against thresholds Tᵤ and Tₑ.

In the Audio Feature Extractor (1402), incoming speech is segmented into 1 second windows. For each window the module computes: words per second (WPS), pitch contour, spectral energy and keyword flags.

The Lexical Sentiment Analyzer (1404) transcribes the text received from the user (either as audio or text) and tokenizes and passes the transcribed text through a sentiment classifier to detect negative polarity and frustration phrases (e.g., not happy, this is bad).

The Scoring Model (1406) has the following parameters:
Input vector: [symbol] WPS, ΔPitch, Energy, KeywordFlags, SentimentScore [symbol] .
Model: logistic regression or shallow neural network trained on 10 k labelled calls (parent disclosure paragraph nos. 85 to 88).
Outputs: urgency score U₁, uneasiness score U₂ (0-1 range).

The Escalation Controller (1408) has the following parameters:
Priority Handling: If U₁≥Tᵤ₁ (e.g. 0.6) but U₂ below Tₑ, the agent reorders planned actions so the urgent request is handled first (parent disclosure paragraph nos. 88-89).
Human Escalation: If U₂≥Tₑ (e.g. 0.8 for >3 s) or user explicitly requests-manager, controller invokes a call bridge to a live representative (parent disclosure paragraph nos. 85-87).

Offline optimization: Post call data (features, scores, final outcome) are stored; thresholds and model weights are periodically tuned to minimize false escalations.

Deployment: Feature extraction may execute in browser WebAssembly; scoring model can reside client or server side depending 25 on latency requirements.

Privacy: Audio features are numeric; raw audio discarded after 30s unless needed for quality assurance.

The Urgency/Uneasiness Scoring Engine of the present invention augments the virtual agent system of Indian Patent 312437. The invention ensures urgent or dissatisfied users receive timely human assistance, improving service quality.

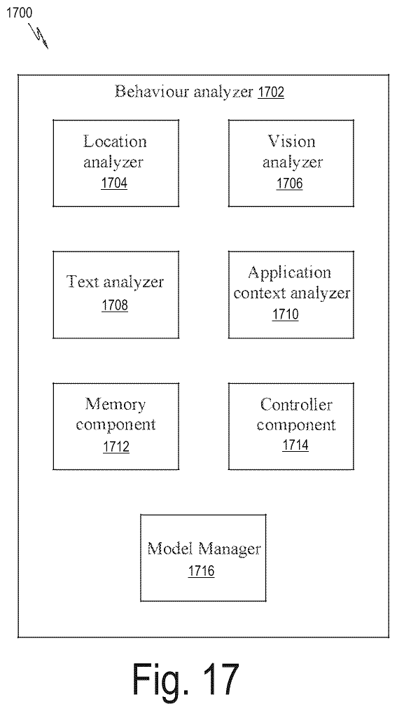

Referring to FIG. 17, a system 1700 is provided for generating content and recommending actions. The system 1700 is configured to generate content and recommend actions on a user device using a behaviour analyzer 1702.

The behaviour analyzer 1702 may be configured to learn the behaviour of a user of a device. The behaviour analyzer 1702 may learn the behaviour of the user by continuously studying the interactions of the user with the device. The behaviour analyzer 1702, may form a hypothesis on the activities of the user by continuously learning from the user interactions with different applications installed on the device and may generate content in a timely manner. The activities may include calling an individual, texting the individual after the phone call, capturing a photo, updating the photo on a social media, ordering food online and so on. The different applications installed on the device may be calling applications, messaging applications, call recorder, social media applications like FACEBOOK, INSTAGRAM, WHATSAPP and so on, online food ordering applications like SWIGGY, ZOMATO and so on. The device may be a mobile. As an example, a user may use the device to capture a photo using a photo capturing application. If the user generally posts the photo using another application, such as a social networking application, after capturing the photo, then there is a high probability that the user will share the currently captured photo on the social networking application. The behaviour analyzer 1702 may have already learned about this behaviour of the user and would suggest the user to upload the photo on to the social networking application, after the photo is captured.

In an embodiment, to learn the user behaviour and predict the user actions, the behaviour analyzer 1702 may have a location analyzer 1704, a vision analyzer 1706, a text analyzer 1708, an application context analyzer 1710, a memory component 1712, a controller component 1714 and a model manager 1716.

The location analyzer 1704 may be configured to identify the location of the user/device and the characteristics of the location. As an example, the location analyzer 1704 may implement a triangulation method to determine the location of the user and may use available meta data around the location data to determine the characteristics of the location. The metadata may be an event entered by the user in the calendar application. The event may be a conference to be attended by the user on a specific date. As an example, the location analyzer 1704 may determine that the user is in a conference room, based on the identified location and the metadata information from the calendar.

The vision analyzer 1706 may be configured to analyse the images captured by the camera installed on the user device and the associated metadata. The metadata may be a birthday event, a picnic spot and so on. The vision analyzer 1706 may also analyse the device screen. The vision analyzer 1706 may break down the device screen into a series of pixels and then pass these series of pixels to a neural network. The neural network may be trained to recognize the visual elements within the frame of the device. By relying on a large database and noticing the emerging patterns, the vision analyzer 1706 may identify position of faces, objects and items, among others, in the frame of the device. The vision analyzer 1706 may thus act as the “human eye” for the device.

The text analyzer 1708 may be configured to parse text in order to extract information. The text analyzer 1708 may first parse the textual content and then extract salient facts about type of events, entities, relationships and so on. As an example, text analyzer 108 may identify the trend of messages the user may send to specific people.

The application context analyzer 1710 may be configured to analyse the past behaviour of the user. For the behaviour analyzer 1702 to predict the actions of the user, the past behaviour of the user should be studied. As an example, the user may call (using a first application) an individual. After the call ends, the user may send a text (using a second application) this individual. This series of behaviour (calling and then texting) may be repeated majority of the times the user makes phone calls to this specific person. The application context analyzer 1710 may analyse this series of past behaviour of the user. The output of the application context analyzer 1710 is to determine how the past behaviour of the user of the device will impact his future actions. The memory component 1712 may be configured to store the previous events/actions corresponding to the user. In context of the above example, the series of actions spread across multiple applications, of the user (calling and then texting) may be stored in the memory component 1712.

The controller component 1714 may be configured to coordinate with the location analyzer 1704, the vision analyzer 1706, the text analyzer 1708, the application context analyzer 1710 and the memory component 1712 to gather information of the behaviour of the user to predict the content and actions for the user.

The model manager 1716 may manage a personalized model 308a that is built for a specific user of the device. The model manager 1716 may also learn to manage the behaviour of a new user of a device. The behaviour analyzer 1702 may be personalized to predict the content and actions according to the individual's behaviour. The behaviour of one user may be different from that of another. As an example, a specific user may upload the photo captured (using first application) to a social media application (a second application) without editing (using a third application) the photo. Another user may upload the picture after editing them.

The model manager 1716 may be trained to learn the particular behaviour of the user of the device to personalize the behaviour analyzer 1702. The model manager 1716 may learn from the feedback on the content and action recommendations of the user.

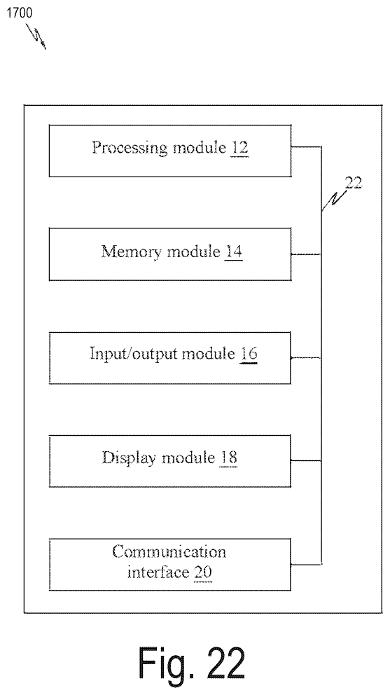

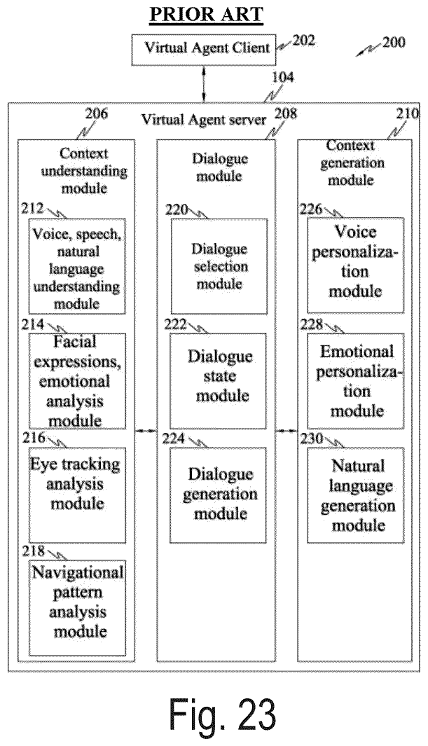

The behaviour analyzer 1702 may be implemented in the form of one or more processors and may be implemented as appropriate in hardware and software. Referring to FIG. 22, software implementations of the processing module 12 may include device-executable or machine-executable instructions written in any suitable programming language to perform the various functions described herein. The behaviour analyzer 1702 can run as offline process, whenever the user starts an application or as a process which executes every ‘x’ minutes or so. The number ‘x’ can be a configurable parameter.

A generalized model 1808a may be trained based on a user cluster. The generalized model 1808a may be introduced in the user device. The model manager 1716 of the behaviour analyzer 1702 may then personalize the generalized model 1808a. As an example, as per a generalized model, the users of a specific cluster may capture a photo (using a first photo capturing application), edit the photo (using a second editing application) and uploading the edited photo to a first social networking application (using a third application). Whereas, a personalized model for a specific user could be, capture a photo (using the first photo capturing application), edit the photo (using the second editing application) and uploading the edited photo to a second social networking application (using a fourth application). In an embodiment, the model manager 1716 may initialize the generalized model 208a either during device setup or as part of the booting process.

Having discussed about the various modules involved in predicting the actions of the user and recommending content, the different implementations of the behavior analyzer 1702 is discussed hereunder.

The behaviour analyzer 1702 may generate content and recommend actions for the user based on the past behaviour of the user. A generalized model 1808 may be trained on the user cluster. The generalized model 1808 may be trained for a group of users with similar profile. The generalized model 1808 may then be personalized for a specific user of the device, which may be called as personalized model 1908a. The behaviour analyzer 1702 may record actions of the user, to personalize the generalized model 1908a. The actions may be performed across plurality of applications installed on the device. The personalized model 1908a may recommend actions based on the recorded actions and may recommend a follow on action to be carried out on a second application. As an example, the follow on action may be uploading a photo on a social networking application (second application) after the photo is captured using a mobile camera application (first application).

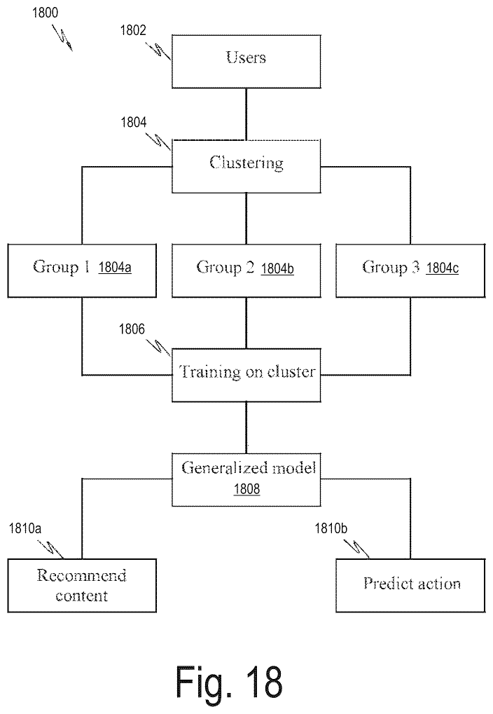

Referring to FIG. 18, at step 1804, the users may be clustered using a learning algorithm. The clustering of the users may result in generation of different user clusters, group 1 1804a, group 2 1804b and group 3 1804c. The generalized model 1808 may then be trained using a Neural network on the training data for the user clusters. Referring to step 1810a and 1810b, the trained generalized model 1808 may recommend content and predict actions for the users of specific clusters using a prediction algorithm.

Having provided an overview of the steps involved in building the generalized model 208a, each of the steps is discussed in greater detail hereunder.

In an embodiment, referring to FIG. 18, at step 1804, the users can be clustered using the learning algorithm. The learning algorithm may be K-means clustering algorithm. K-means clustering groups an unlabelled data. An unlabelled data includes data without defined categories or groups. All of the users may form the unlabelled data. The K-means clustering algorithm find groups in the unlabelled user data, with the number of groups represented by the variable “K”. The algorithm works iteratively to assign each user (data point) to one of “K” groups based on the features of the user. The users may be clustered based on feature similarities. The features of the user may be age, behavioural characteristics, gender and so on. The output of K-means clustering algorithm may be clusters of users, group 1 1804a, group 2 1804b and group 3 1804c, wherein each cluster may have similar features.

At step 1806, the user cluster may be trained using a deep Neural Network on large training data on the users of the cluster. The user cluster may be trained using the training data from the location analyzer 1704, the vision analyzer 1706, the text analyzer 1708, the application context analyzer 1710 and the memory component 1712 within the user cluster. As an example, the user cluster may be trained to upload a photo on FACEBOOK using training data. The location analyzer 1704 may have data about the location of the picture, the vision analyzer 1706 may have the image that has to be uploaded, the application context analyzer 1710 may have the data pertaining to the behaviour (uploading photo) of the cluster and this data may be stored in the memory component 1712.

At step 1808, the trained user cluster may form the generalized model 1808 for specific user cluster. At step 1810a and 1810b, the generalized model 1808 after learning the behavioural pattern of the cluster may recommend content and predict actions for the cluster based on the behavioural pattern of the cluster. In an embodiment, the generalized model 208a may predict a sequence of actions for the user cluster by using a Recurrent Neural Network (RNN). RNN algorithm is designed to work with sequence predictions. Sequence is a stream of data which are interdependent. RNN algorithm will have an input loop, an output loop and hidden layers between the input loop and the output loop. The output from a previous step will be taken as input for a current step. In this way RNN creates a network of input loops, process these sequence of inputs that are dependent on each other to predict the final output sequence. The generalized model 208a may continuously learn from the behavioural pattern of the cluster. As an example, the user may have a behavioural pattern of capturing a photo, editing the photo after capturing, uploading the photo on FACEBOOK and then sharing the same on INSTAGRAM. The RNN algorithm will process this sequence. The next time the user captures a photo and edit them, the generalized model 208a will recommend the user to upload the photo on FACEBOOK and then to share the same on INSTAGRAM. In an embodiment, the generalized model 1808 may predict application actions for the user cluster by using a Deep Neural Network (DNN). The application actions may be sending a SMS (Short Message Service) to a friend, calling a merchant and so on.

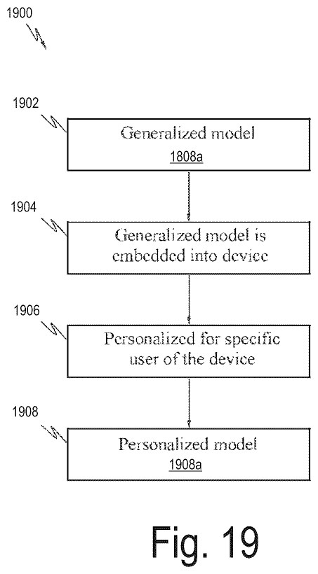

Referring to FIG. 19, at step 1904, the trained generalized model 1808 of the behaviour analyzer 1702 may be embedded into the user device. The user may have carried out different actions across different application installed on the device before the generalized model is embedded on the device. When the generalized model 1808 is embedded on the device, these sequence of actions may be learned by the generalized model 1808. The sequence of actions may be specific to a specific user of the device. The embedded generalized model 1808 may thus be personalized for the specific user of the device, at step 1906. The personalization of the generalized model 1808 may generate a personalized model 1908a (step 1908). The personalized model 1908 may predict follow up actions based on the sequence of actions of the user.

In an embodiment, the personalization of the behaviour analyzer 1702 may be implemented using the learning algorithm. The learning algorithm may be Reinforcement Learning. Reinforcement Learning uses the concept of agent, actions, states and reward to attain a complex objective (content recommendation and action for the user of the device). As an example, the aggregated user behaviour, updates from the social media may be the state for the user. Content recommendation, displaying an application action may be the action of the algorithm. Correctly predicting the action at time “t” may be the reward function. In Reinforcement Learning, the agent (behaviour analyzer 1702) may be provided with the state. The agent may then take an action for the corresponding state. If the agent is successful in predicting the action at time “t”, then the agent will be rewarded with positive points (“+1”). If the agent is unsuccessful in predicting the action at time “t”, then the agent will be punished with negative points (“−1”). The agent will try to maximize the cumulative reward functions to achieve the best possible action. To figure out the action, the behaviour analyzer 1702 may implement policy learning algorithm. As an example, the behaviour analyzer 1702 may recommend uploading a picture using a social networking application after capturing the picture. In case the user accepts the recommended action, then the behaviour analyzer 1702 may be awarded a positive point. Else, the behavior processor 1702 may be awarded a negative point. The behavior analyzer 1702 may attempt to maximize the positive point to correctly predict the action of the user next time the user captures a photo. The personalized model 1808 may maximize the positive points based on the acceptance (positive points) or rejection (negative points) of the actions recommended by the behaviour analyzer 1702. As an example, if the user accept to upload the photo after capturing the photo, the behavior analyzer may be rewarded with a positive point. Whereas, if the user do not upload the photo after capturing the photo, the user may obtain a negative point. Based on these negative and positive points, the personalized model 1808 may be refined. The In another embodiment, the behavior analyzer 1702 may implement value iteration algorithm to figure out the action.

In another embodiment, an End-to-End Neural Network using an architecture consisting of Policy Gradient Deep Reinforcement Learning on top of a Deep Neural Network (DNN) may be applied. The DNN with attention can generate user behavior embeddings on the offline user cluster behaviour data. The generic model then can be personalized for the user by adjusting the loss function in the Policy Gradient Deep Reinforcement Learning to predict the user actions.

In yet another embodiment, generalized model 1808 may be trained to do imitation learning for user clusters on the behaviour sequence data. The user behaviour can be trained by implementing one shot learning algorithm.

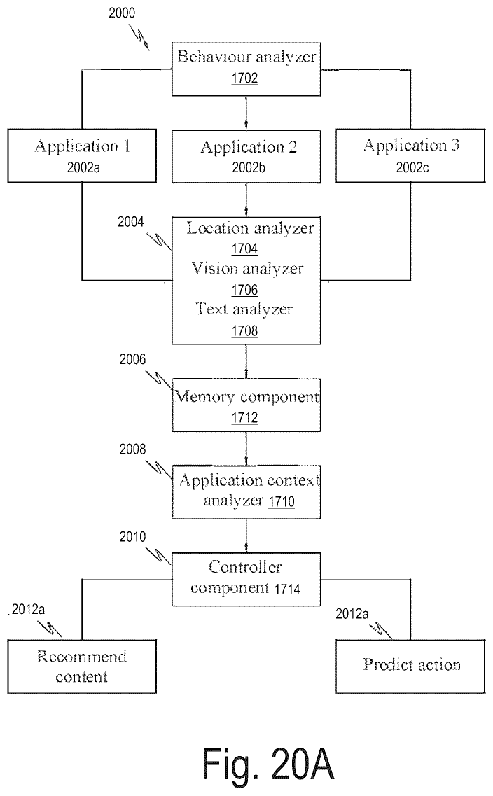

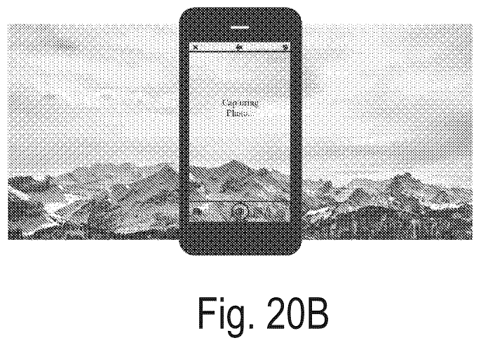

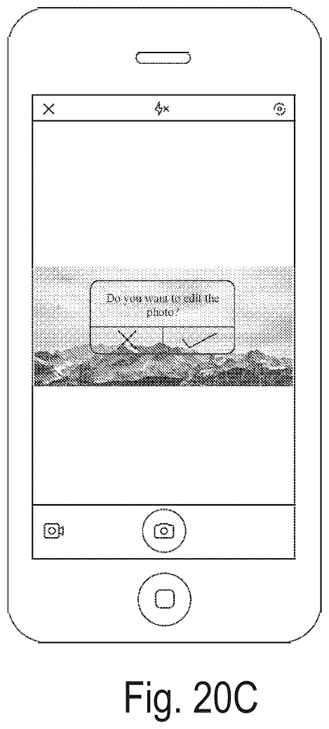

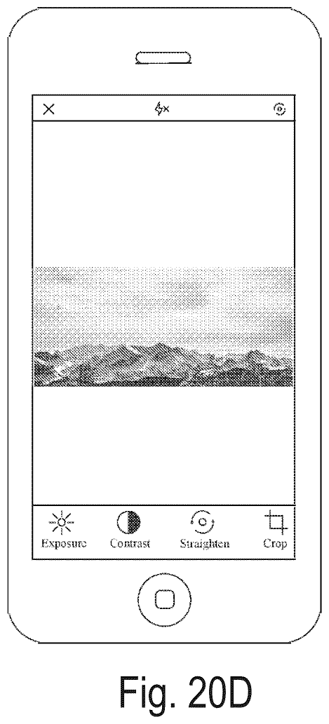

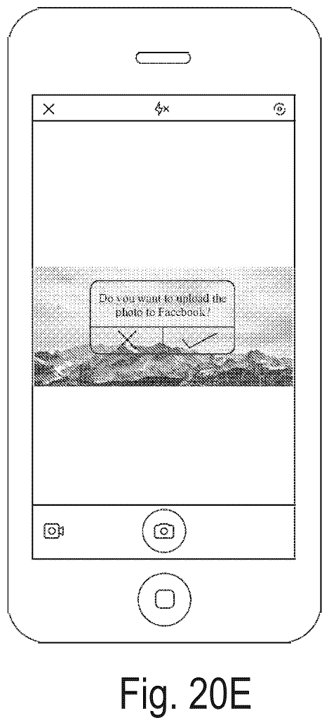

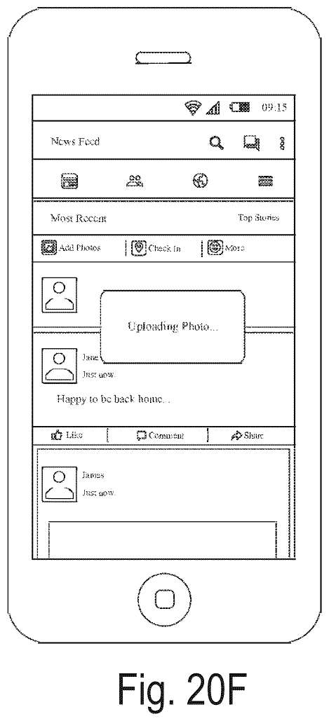

Referring to FIG. 20A, the behavior analyzer 1702 may continuously learn from interactions of users with the different applications, application 1 2002a, application 2 2002b and application 3 2002c, installed on the mobile. As an example, the application 1 2002a may be camera application, the application 2 2002b may be a photo editor and the application 3 2002c may be a social networking application. There may be more than 3 applications. At step 2004, the location analyzer 1704, the vision analyzer 1706 and the text analyzer 1708 may collect data and information from the different applications, application 1 2002a, application 2 2002b and application 3 2002c. As an example, the data and information stored may include images captured by the camera application (application 1 2002a), editing behavior of the user in the photo editor (application 2 2002b), uploading behavior of the user on the social networking application (application 3 2002c), different events stored in the calendar (application 4 (not shown)), and so on. At step 2006, the data and information collected from the application 1 2002a, the application 2 2002b and the application 3 2002c may be stored in the memory component 1712. At step 408, the data stored in the memory component 1712 may be analyzed by the application context analyzer 1710. The application context analyzer 1710 may analyses the context of the actions in which the user had previously carried out the follow up actions after carrying out a first action. The context of the action may be based on the location of the device where the action is carried out and/or characterizing information associated with the location where the action is carried out and/or the time at which the action is carried out and/or the scheduled event at the time at which the action is carried out. As an example, the user may only upload the photos that are captured, at morning, on a picnic spot and may not upload photos captured at the user's office or any other time. At step 2010, the controller component 1714 gathers the data and the information to determine the behavior of the user. At step 2012a and 2012b the controller component 1714 may recommend content and predict actions of the user if the context in which the first action is carried out correlates with the context in which the user had previously carried out the follow up action after carrying out the first action. As an example, the controller component 1714 may gather the image from the camera application, editing behavior from the photo editor application, uploading behavior of user, at different events, from social networking application and event marked in calendar to arrive at the conclusion that the user may upload photos, if the photos are captured at a picnic spot at morning time.

FIG. 20B, FIG. 20C, FIG. 20D, and FIG. 20E illustrates an exemplary method of predicting user actions, by the behaviour analyzer 1702. Referring to FIG. 20B, the user of the mobile may open camera application (application 1 2002a) to capture photo on New Year. As soon as the user completes capturing the photo, the behaviour analyser 1702 may send a pop-up “Do you want to edit the photo?” (FIG. 20C). If the user wishes to edit the photo, he may select “ü”. The behaviour analyzer 1702 may open the photo editor application (application 2 2002b) for the user, wherein the user can edit the photo (FIG. 20D). Referring to FIG. 20E, on completion of photo edition, the behaviour analyzer may send another pop-up “Do you want to upload the photo on FACEBOOK?”. If the user wants to upload the photo on FACEBOOK, the user may select “ü”, on which the behaviour analyzer 1702 may upload the photo in the user's FACEBOOK (FIG. 20F). Referring to FIG. 20E, if the user do not wish to upload the photo in FACEBOOK, then he may select “x”, on which the behavior analyzer 1702 may take the user back to the camera application. Referring to FIG. 20C, if the user do not want to edit the photo, then he may select “x”, upon which the behaviour analyzer 1702 may send a pop-up “Do you want to upload the photo on FACEBOOK?” (FIG. 20E). The user may select “ü”, if he wishes to upload the photo in FACEBOOK, on which the behaviour analyzer 1702 may upload the photo in the user's account in FACEBOOK (FIG. 20F). If the user do not wish to upload the photo in FACEBOOK, then he may select “x”, on which the behaviour analyzer 1702 may take the user back to his camera application.

In conventional methods, to benefit from an application, the user may have to first open the application and then browse through the menu option available in the application. To successfully operate the application, the user should have a basic knowledge about method of operation of the application. Further, on facing any issues in browsing the application, the user may have to call the customer care to resolve the issue. In an embodiment, the behavior analyzer 1702 may act as a virtual agent for the user. The behavior analyzer 1702 may use embodiments mentioned in patent application Ser. No. 15/356,512, which is herein in cooperated by reference, to understand the context of the application and act as the virtual agent. The behavior analyzer 1702 may use the data from the location analyzer 1704, the vision analyzer 1706, the text analyzer 1708, the application context analyzer 1710, the memory component 1712, the controller component 1714 and the model manager 1716 to extract information on the application context and may learn the intentions of the user from the user's past behavior. The application context may include information about text and images in the applications, the contents in the application which the user is interested in and so on. Based on these, the behavior analyzer 1702 may answer questions about the services in the application. The behavior analyzer 1702 may also do actions on the application, on behalf of the user. The behavior analyzer 1702 may interact in natural language with the application. As an example, the user may be interested in ordering food online. The behavior analyzer 1702 may filter food in accordance with the past behavior of the user. The behavior analyzer 1702 may also do other action such as placing the order, choosing the payment options, making payment and so on.

In an embodiment, the behaviour analyzer 1702 may use imitation learning algorithm to execute actions in the application. Imitation learning algorithm take behavioral pattern of the user as input and will replicate the behavior of the user to execute actions on behalf of the user. In another embodiment, the behavior analyzer may execute actions on behalf of the user by implementing one shot learning. One shot learning require minimum amount of data as input to learn the behavior of the user.

The behavior analyzer 1702 may act as a virtual agent for the ecommerce applications. The user of the ecommerce application, before purchasing a product may want to see how the product may look in a suitable environment. Such an experience is possible by Augmented reality. Augmented reality is an interactive experience of a real world environment whereby elements of the virtual world is brought into the real world for enhancing the environment that the user experience. As an example, the user may purchase a sofa set from an ecommerce application such as AMAZON, FLIPKART and so on. In conventional approach, the user may have to choose the sofa set from the ecommerce application, open the camera application installed on user's mobile, point the camera at living room, drag the sofa set and then place the sofa set on the desired location to get a physical sense of how the sofa set fits in user's living room. The user may want to see how the product fits in his living room before finalizing on the product.

In an embodiment of the subject matter disclosed herein, the behaviour analyzer 1702 may place the sofa set in the user's living room, on his mobile screen, to give a physical sense of how the sofa set looks in his living room.

In an embodiment, the behaviour analyzer 1702 may act as a virtual agent, for executing the Augmented reality, for the ecommerce applications by first understanding the action and then completing the action. As an example, the action may be placing the sofa set on the user's living room.

In an embodiment, the behaviour analyzer 1702 with access of data from the location analyzer 1704, the text analyzer 1708, the application context analyzer 1710, the memory component 1712, the controller component 1714 and the model manager 1716 may act as a virtual agent for the ecommerce application. The virtual agent may take the voice input of the user, convert the voice to text to understand the action intended by the user. Other information elements required for understanding the action may be figured out using slot filing algorithm. In an embodiment, additional context that may be helpful for the virtual agent may be provided manually by the user. The additional context may include bitmap of the physical visual images captured by the camera of the device, textual description of the image and so on.

In an embodiment, the virtual agent may be trained to understand the virtual image in an ecommerce application (example: Sofa set), the title and the category of the image, the physical context and the natural language utterance by implementation of Neural module network.

After understanding the actions, the behaviour analyzer 1702 as an agent may need to complete the action. As an example, the behaviour analyzer 1702 may move the sofa set from one corner of the living room to the other corner. The action can be completed by the virtual agent, manually, by taking the input given by the user in natural language voice input. The user may give input to the virtual agent, which in turn may convert the natural language voice input to text input and then complete the action.

In an embodiment, the virtual agent may complete the actions by itself. The virtual agent may be trained by Deep Neural Network algorithm to automatically complete the actions. In an embodiment, Deep Reinforcement Learning approach on top of Neural Modules may be used for natural language understanding, object detection and scene understanding to execute actions.

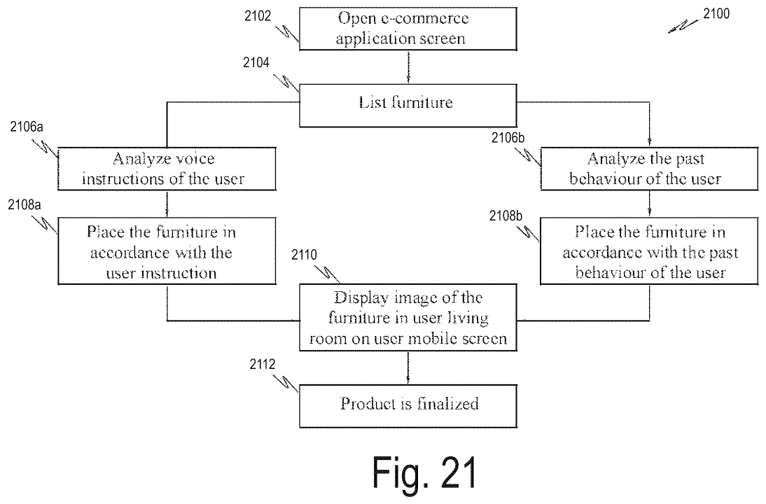

As an example, referring to FIG. 21, at step 2102, the user opens an e-commerce application. The user may browse through different products available on the application and at step 2104, the user may select a furniture for the user's living room. After the selection of the furniture, the user may provide voice instructions to the behaviour analyzer 1702 for placing the furniture in the living room (step 2106a-step 2108a). Alternatively, the behaviour analyzer 1702 may analyse the past behaviour of the user and suggest placing the furniture in the living room on behalf of the user (step 2106b-2108b).

In an embodiment, at step 2106a, the user may give voice instructions to the behaviour analyzer 1702. The voice instructions of the user may be converted to text by the behaviour analyzer 1702 to understand the intent of the user. At step 2108a, the behaviour analyzer 1702 may place the furniture in accordance with the instruction provided by the user, in the image of the living room as displayed in the mobile screen of the user. At step 2110, the user may get a visual experience of the furniture in the living room. If the user is satisfied with the product, the user may finalize on the product (2112) for purchase.

In an embodiment, at step 2106b, the behaviour analyzer 1702 may analyse the past behaviour of the user to complete the action intended by the user. At step 2108b, the behaviour analyzer 1702 may place the furniture in the living room, in accordance with the past behaviour of the customer. At step 2110, the user may get a visual experience of the furniture placed in the living room, on his mobile. If the user is satisfied with the product, at step 2112, the user may finalize the product for purchase.

In another embodiment, the virtual agent may execute actions by training the virtual agent by implementation of Imitation learning.

Having provided the description of the different implementations of the system for predicting the actions of the user and recommending contents based on user behavior, hardware elements of the system is discussed in detail hereunder.

FIG. 22 is a block diagram illustrating hardware elements of the system of FIG. 17, in accordance with an embodiment. The system may be implemented using one or more servers, which may be referred to as server. The system may include a processing module, a memory module, an input/output module, a display module, a communication interface, and a bus interconnecting all the modules of the system.

The processing module is implemented in the form of one or more processors and may be implemented as appropriate in hardware, computer executable instructions, firmware, or combinations thereof. Computer-executable instruction or firm-ware implementations of the processing module may include computer-executable or machine-executable instructions written in any suitable programming language to perform the various functions described.

The memory module may include a permanent memory such as hard disk drive, may be configured to store data, and executable program instructions that are implemented by the processing module. The memory module may be implemented in the form of a primary and a secondary memory. The memory module may store additional data and program instructions that are loadable and executable on the processing module, as well as data generated during the execution of these programs. Further, the memory module may be a volatile memory, such as a random access memory and/or a disk drive, or a non-volatile memory. The memory module may comprise of removable memory such as a Compact Flash card, Memory Stick, Smart Media, Multimedia Card, Secure Digital memory, or any other memory storage that exists currently or may exist in the future.

The input/output module may provide an interface for input devices such as computing devices, keypad, touch screen, mouse, and stylus among other input devices; and output devices such as speakers, printer, and additional displays among others. The input/output module 16 may be used to receive data or send data through the communication interface.

The input/output module can include Liquid Crystal Displays (OLCD) or any other type of display currently existing or which may exist in the future.

The communication interface may include a modem, a network interface card (such as Ethernet card), a communication port, and a Personal Computer Memory Card International Association (PCMCIA) slot, among others. The communication interface may include devices supporting both wired and wireless protocols. Data in the form of electronic, electromagnetic, optical, among other signals may be transferred via the communication interface.

It should be understood, that the capabilities of the invention described in the present disclosure and elements shown in the figures may be implemented in various forms of hardware, firmware, software, recordable medium or combinations thereof.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention. Thus, the scope of the invention should be determined by the appended claims and their legal equivalents rather than by the examples given.

Throughout this specification, the use of the word —comprise| and variations such as —comprises and —comprising may imply the inclusion of an element or elements not specifically recited.

The present invention is directed to an improvement or modification of the invention claimed in Indian patent application numbered 201644039413 dated 18 Nov. 2016 with priority date 20 Nov. 2015, titled —Systems and Methods for Virtual Agents to Help Customers and Businesses and patent number 312437.

The parent patent discloses a system that includes a virtual agent client and virtual agent server; wherein the server performs NLU/dialogue, maintains tags and correlations between application actions, and the client instantiates actions including filling input fields and clicking buttons. Mappings between user intents and actions can be crawled or configured; the VA may interact with external systems for completing transactions; 5 image/pixel inputs are contemplated for semantic understanding and personalization.

The present invention adds pixel level screen perception fused with language and application map knowledge, JEPA-style action embeddings, a world action model trained across applications/screens, an agentic ReAct planning loop that mixes UI actions and tool/external agent calls, and a gating function that routes between on-device and remote world models under privacy/latency/resource constraints.

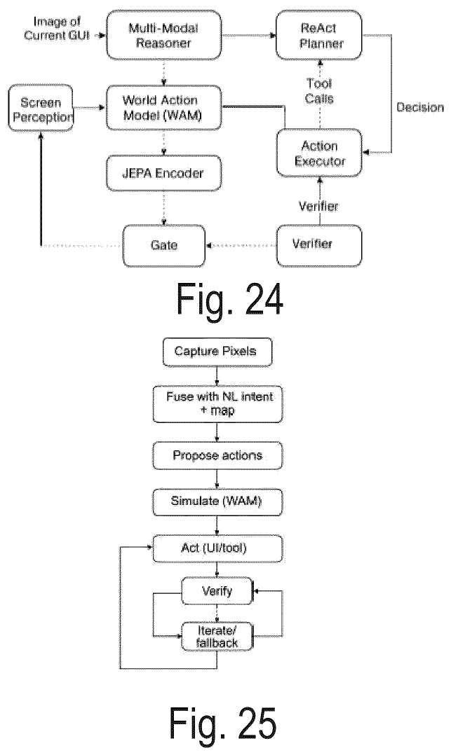

FIG. 24 illustrates the improved virtual agent system architecture comprising multiple interconnected modules for controlling graphical user interfaces based on multimodal input. The system includes:
i Screen Perception Module: Captures live pixels of the graphical user interface (GUI) via OS compositor snapshots, accessibility APIs, or framebuffer capture.
ii Multimodal Reasoner: Fuses pixel data, natural language input, and application map knowledge to generate UI action plans.
iii JEPA Encoder: Encodes masked region representations and produces action embeddings aligned to UI regions and tool signatures.
iv World Action Model (WAM): Predicts next-state latents, goal satisfaction values, and auxiliary signals based on current state and candidate actions.
v ReAct Planner: Executes a planning loop that selects between pixel-grounded UI actions, external API calls, or agent invocations, incorporating tool results as observations.
vi Tool Router: Manages invocation of external tools, APIs, or agents, and maintains latency, cost, and privacy priors.
vii Action Executor: Injects OS level UI events (click, tap, scroll, drag, keypress) at pixel coordinates derived from the plan.
viii Verifier: Performs closed-loop verification by re-capturing pixels and comparing observed outcomes with predicted latents.
ix Gate: Routes inference between local (on-device) and remote models based on privacy classification, latency, resource availability, and model confidence.

In FIG. 24, the arrows between modules indicate the flow of data and control, including feedback loops from the Verifier to the Multimodal Reasoner and routing decisions from the Gate to the WAM and ReAct Planner.

FIG. 25: visually represents the process flow of the improved virtual agent system, from pixel capture through reasoning, simulation, action execution, verification, and fallback. It illustrates the process flow executed by the improved virtual agent system for controlling graphical user interfaces based on multimodal input and predictive planning. The flow comprises the following sequential steps:
i Capture Pixels: Acquiring the current graphical user interface
ii (GUI) raster via OS compositor snapshot, accessibility API, or framebuffer capture.
iii Fuse with Natural Language Intent+Map: Combining the pixel data with user-provided natural language input and any available application map or crawl-derived associations.
iv Propose Actions: Generating candidate UI actions and tool invocations based on fused multimodal context.
v Simulate (WAM): Using a World Action Model (WAM) to simulate the predicted outcome of each candidate action and evaluate goal satisfaction.
vi Act (UI/tool): Executing the selected action either through pixel-referenced UI events (e.g., click, scroll, type) or invoking external tools or agents.
vii Verify: Re-capturing the GUI pixels post-execution and 5 comparing the observed state against the predicted latent to confirm success.
viii Iterate/Fallback: If verification fails or confidence is low, the system either replans and retries or falls back to selector-based execution as disclosed in the parent patent.

Arrows between steps indicate the directional flow of control and feedback. The loop from “Verify” to “Propose Actions” represents closedloop iteration, while the path to “Iterate/Fallback” enables graceful degradation.

In one or more embodiments, the present invention implements a computer-implemented method for controlling a graphical user interface (GUI) in which a user's natural-language instruction is translated into pixel-referenced user-interface operations. In such embodiments, the system receives a natural-language instruction specifying a user goal, acquires pixel data representing a current visual state of the GUI, and generates a plan of one or more user-interface operations referenced to pixel regions of the GUI. The plan is executed by injecting operating system-level input events at coordinates derived from the referenced pixel regions, followed by closed-loop verification using re-acquired pixel data to determine whether the user goal has been satisfied.

For an instruction such as “open my profile settings”, the system captures the current screen pixels, identifies a navigation icon via pixel analysis, generates a click operation referenced to the localized pixel region of the icon, injects a pointer event at the derived coordinates, and verifies success by detecting the appearance of a profile settings screen in the re-acquired pixel data.

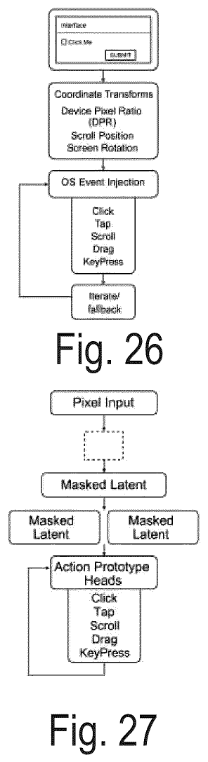

FIG. 26 illustrates the full flow of the pixel-level localization of fields and controls; coordinate transforms (DPR, scroll, rotation); OS event injection. It illustrates the process by which the virtual agent system identifies interactive elements on a graphical user interface (GUI) and executes actions through operating system-level event injection. The flow comprises:
i Pixel-Level Localization: Detection of fields, buttons, sliders, and other controls using pixel data derived from the GUI raster.
ii Coordinate Transforms: Adjustment of pixel coordinates to physical screen coordinates using device-specific parameters
iii including:
iv Device Pixel Ratio (DPR)
v Scroll Position
vi Screen Rotation
vii OS Event Injection: Execution of user interface actions by injecting operating system-level events such as:
viii Click
ix Tap
x Scroll
xi Drag
xii KeyPress

Arrows between modules indicate the directional flow of data and control. This figure supports the claim elements related to pixel-based UI interaction and device-aware execution.

In one embodiment, executing a planned user-interface operation comprises injecting an operating system-level input event at coordinates derived from a referenced pixel region. Prior to injection, the system performs coordinate transforms to account for device pixel ratio, window origin, viewport scroll position, and screen rotation, thereby ensuring correct physical targeting across heterogeneous devices.

On a mobile device with a high device pixel ratio and a rotated display, the system converts a predicted pixel-region bounding box into adjusted physical coordinates and injects a tap event at the transformed location to activate a button that is partially off-screen due to scrolling.

FIG. 27 illustrates the training architecture of the Joint Embedding Predictive Architecture (JEPA) used in the improved virtual agent system. The diagram comprises the following components:
i Pixel Input: A rasterized image of the graphical user interface (GUI), with one or more regions masked to simulate partial observation.
ii Masked Latent Encoder: A non-generative encoder trained to 15 predict latent representations of the masked regions using surrounding pixel context, natural language input, and optional application map features.
iii Action Prototype Heads: A set of output heads aligned to specific UI primitives and tool actions, including:
   Click
   Drag
   Type
   Scroll
   Tool Invocation

Each action head binds the predicted latent representation to a corresponding action embedding, enabling downstream modules to select and execute contextually appropriate operations.

Arrows between modules indicate the flow of data from input to latent encoding to action prediction. This architecture supports self-supervised pre-training and fine-tuning for pixel-grounded UI control.

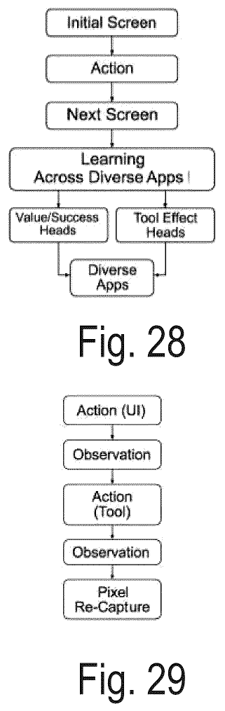

FIG. 28: illustrates the training architecture of the World Action Model (WAM) used in the improved virtual agent system. The model learns predictive representations from screen transitions triggered by user or agent actions across diverse applications. The training process comprises:
i Input Triples: Each training example consists of a tuple (Initial Screen, Action, Next Screen), representing the observed transition caused by a UI event or tool invocation.
ii WAM Encoder: Processes the input triple to generate latent 10 representations of screen states and action embeddings.
iii Learning Across Diverse Apps: The model is trained on heterogeneous screen flows from multiple applications, devices, and viewports, enabling generalization to unseen interfaces.
iv Value/Success Heads: Predict goal satisfaction metrics,
v including probability of success, clickability, field state deltas, and error likelihood.
vi Tool Effect Heads: Model the impact of external tool/API/agent calls on screen transitions, including JSON I/O
vii and latent state changes.

Arrows indicate the flow of data from screen-action-screen triples to latent encoding and prediction heads. This architecture supports imitation learning, offline reinforcement learning, and model predictive control.

FIG. 29: illustrates the ReAct loop timeline executed by the virtual agent system for dynamic task completion. The loop comprises alternating steps of user interface (UI) interaction and external tool invocation, each followed by observation and pixel verification. The sequence includes:
i Action (UI): Injecting pixel-referenced operating system events such as click, scroll, drag, or type to manipulate the graphical user interface.
ii Observation: Capturing the resulting screen state and evaluating intermediate progress toward the goal.
iii Action (Tool): Invoking external tools, APIs, or agents to retrieve, process, or modify data relevant to the task.
iv Observation: Ingesting tool outputs and updating the reasoning context.
v Pixel Recapture: Re-acquiring the GUI raster to verify the outcome of the previous action or tool call.
vi Iteration or Termination: Based on verification and goal satisfaction, the system either continues the loop or terminates execution.

In an embodiment, the system iteratively executes a planning loop comprising observing pixel data and tool outputs, proposing a candidate user-interface action or tool invocation, simulating an outcome using a world action model, acting by injecting an operating system-level input event or invoking the tool, verifying by re-acquiring pixel data, and repeating until a goal condition or stop condition occurs.

For a request such as “check my refund status”, the system first invokes a backend status tool, ingests the returned data, then performs a pixel-referenced UI action to navigate to a confirmation screen, verifying completion by detecting a refund status message in the GUI.

Arrows between boxes indicate the directional flow of control and feedback. This timeline supports closed-loop planning, dynamic replanning, and fallback strategies as disclosed in the ReAct planner embodiment.

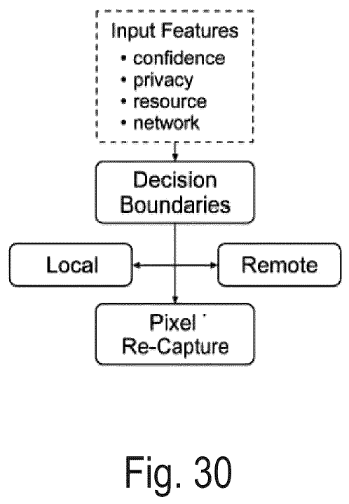

FIG. 30: illustrates the gating architecture used by the virtual agent system to determine whether inference and action execution should occur locally (on-device), remotely (cloud/server), or in hybrid mode. The decision is based on a set of input features and gating thresholds, including:
i Confidence: Model certainty in action prediction or goal satisfaction.
ii Privacy: Classification of screen content or user input as sensitive or restricted.
iii Resource: Availability of compute, memory, and battery on the local device.
iv Network: Latency, bandwidth, and connectivity status.

These features are evaluated by a Decision Boundaries module that routes execution to one of the following paths:
i Local Execution: On-device inference and event injection, used when privacy is high or resources are sufficient Remote Execution: Cloud-based model invocation and tool routing, used when local resources are constrained or confidence is low.
ii Hybrid Modes: Partial local inference with remote tool calls, fallback execution, or staged verification.

Arrows indicate the flow from input features to decision boundaries and execution paths. This architecture supports dynamic routing and privacy-preserving inference across heterogeneous environments.

In various embodiments, inference and action execution are dynamically routed between a local on-device model and a remote model based on model confidence, privacy classification of pixel data, device resource availability, network latency, user-interface complexity, or action risk. In one embodiment, GUI states containing personally identifiable information are processed exclusively on-device. In further embodiments, on-device models are trained or updated using federated learning.

When a screen displays payment details or personal identifiers, the system enforces local-only inference and executes pixel-level actions without transmitting pixel data off-device, while aggregated model updates are later shared via federated learning without exposing raw screen content.

In an exemplary embodiment, a screen perception module obtains the current GUI raster (e.g., OS compositor snapshot, application framebuffer, accessibility screenshot API). A multimodal reasoner encodes the pixels, the user's utterance/text (and dialogue state), and any application map/crawl features (e.g., selectors, prior correlations, form schemas) from the Parent. The reasoner outputs a plan of one or more UI operations with pixel regions (bounding boxes/heatmaps) and arguments (text to type, slider deltas). Selector-based paths remain available when reliable identifiers exist.

In certain embodiments, the multimodal reasoner includes a JEPA-style encoder that predicts masked region representations from the surrounding context (non-generative).

In such embodiments:
A. The Inputs are pixels (+optional OCR tokens and accessibility attributes), utterance/dialogue context, and condensed map/crawl features.
B. The Outputs are (i) region heatmaps, (ii) action embeddings for UI primitives (click/tap/drag/scroll/type/keypress/submit) and tool invocations (API/agent with schema), and (iii) tool match scores.
C. Training: region masking; multi-scale crops; theme/DPI randomization; action prototype heads bind embeddings to UI primitives and tool signatures.

In certain embodiments, generating the plan comprises producing one or more region heatmaps that localize interactive user-interface elements within the pixel data and binding each localized region to an interaction primitive selected from click, tap, drag, scroll, keypress, submit, or type. The localization and binding are performed using a non-generative masked-latent encoder that predicts masked region representations from surrounding pixel context without reconstructing pixel-level data.

When a screen includes multiple text fields, the system masks portions of the pixel input and predicts latent representations to distinguish a “search” field from a “password” field. The localized region corresponding to the search field is bound to a type primitive, enabling the system to enter text into the correct field without relying on application-specific identifiers.

In another embodiment, a world action model receives the current latent screen states (from the JEPA/visual encoder) and a candidate action embedding at (UI primitive or tool/agent call) and predicts:
s\hat{ }{t+1} (next screen latent or tool result latent),
value/success (probability of goal satisfaction, step cost, risk), and
auxiliary signals (clickability, field state deltas, error banner likelihood).

Learning data: triples (xt,at,xt+1) from multiple apps/devices/viewports; tool calls include their JSON I/O; latents derived via the JEPA encoder; imitation learning from Parent logs and crawler based flows; optional offline RL/value learning.

In certain embodiments, prior to executing a user-interface operation, the system simulates candidate actions using a world action model that predicts a next GUI state latent and an associated value metric indicating likelihood of satisfying the user goal. The candidate action is selected based on the value metric before execution. The world action model is trained using transition triples comprising a screen state, an action, and a subsequent screen state obtained across multiple applications, devices, and viewports.

When both a “menu” icon and a “profile” icon are present, the world action model predicts that selecting the menu icon is more likely to lead to an account settings screen. The system selects the higher-value action without trial-and-error execution.

In yet another embodiment, ReAct planner runs a loop: Observe (pixels+latest tool outputs)→Think (propose UI actions and tool calls)→Simulate (score with WAM to look ahead)→Act (inject OS events at predicted pixels or invoke a tool/external agent)→Verify (recapture 20 pixels; compare to s\hat{ }{t+1})→Repeat until a goal condition or stop. Tool/agent results are embedded and concatenated to the state so the next step can condition on prior outcomes. The tool router maintains per tool schemas, latency/cost priors, and a privacy tier; it exposes a tool signature embedding used by the JEPA head to propose tool actions. The external system interactions disclosed in the parent patent serve as concrete tool examples.

In an embodiment, the action executor emits OS/UI events (pointer down/up/move, drag, scroll, keypress/text) at coordinates computed from predicted pixel regions. It performs coordinate transforms for device pixel 30 ratio, window origin, viewport scroll, and rotation. After each action, the verifier recaptures pixels and compares the observed latent to the WAM prediction; if divergence exceeds a threshold, the system self-corrects (relocalize/replan) or falls back to selector-based execution leveraging the Parent's mappings.

In various embodiments, closed-loop verification is performed by re-acquiring pixel data after execution and comparing an observed outcome to a predicted outcome. When a divergence exceeds a threshold, the system automatically self-corrects by re-localizing the target pixel region, re-planning the sequence of actions, or falling back to selector-based execution using pre-existing interface mappings of a parent virtual agent system.

If a click action predicted to open a checkout page instead results in an error banner or unchanged screen state, the system detects the mismatch in re-acquired pixel data and either re-identifies an alternative checkout button or falls back to a known selector associated with the checkout flow.

In an embodiment, a gating function routes inference between a local (on-device) WAM and a remote WAM. The features of such embodiment are: JEPA confidence/entropy; WAM value variance; recent verifier mismatches; privacy classification (on-device OCR/PII redaction); device CPU/GPU/battery/thermals; network RTT/bandwidth; UI complexity; action risk (purchase/delete). The decisions involved in the said embodiment are model route {Local, Remote, Hybrid}; action route {UI pixel, Tool/API, External agent, Selector fallback}. The objective of such embodiment is to maximize task success subject to latency/cost/privacy constraints; enforce hard privacy rules (PII screens→local only). The acceleration is on-device quantized/distilled WAM; incremental re-encoding for small screen deltas.

As regards the training, datasets and privacy aspects of the present improvement, data pertains to cross app logs with (screen, action, next screen), aligned pointer trajectories and tool I/O; domain randomization (DPI, themes, locales); pre-training is carried out vide JEPA encoder self-supervised on UI screenshots; fine-tuned with instruction→demonstration pairs; and safety is ensured through on-device redaction of sensitive regions, screenshots ephemeral post verification, audit logs being keep-only structured, and events being anonymized.

### Working Example of the Present Invention

In an example of the present invention, for the task—Track my order and reschedule to tomorrow evening|, the process flows in the following manner:
JEPA proposes either UI path to Orders or a CheckOrderStatus tool;
router selects tool; tool returns slots;
WAM predicts that Reschedule becomes available;
ReAct chooses UI path to Reschedule;
executor clicks predicted bbox and types the slot; verifier confirms the success banner; done.

The parent patent's external system interactions and programmatic clicks are reused in this path.

### Technical Advantages/Effects of the Present Invention

Robust completion on unseen UIs; reduced reliance on brittle rules; lower latency with local inference; privacy preserving routing; higher success rates through look ahead and tool use; graceful degradation via selector fallback already contemplated by the parent patent.

What has been described and illustrated herein is a preferred embodiment of the invention along with some of its components. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

The present disclosure relates to a computer-implemented method for controlling a graphical user interface of a software application executing on a client device by operating directly on pixel-level visual data and injecting operating system-level input events. In one embodiment, the method begins by receiving a natural-language instruction specifying a user goal, wherein the instruction expresses an intended outcome rather than explicit interaction steps. The instruction may be provided through text input, voice input, or other language-based interfaces and is interpreted as a goal condition to be achieved through interaction with the graphical user interface.

Upon receiving the instruction, the system acquires pixel data representing a current visual state of the graphical user interface, such as a screenshot or rendered surface of the application window or display region. The pixel data reflects the actual appearance of the interface as presented to a human user and is used as the authoritative representation of interface state, independent of application internals, selectors, accessibility metadata, or source code. The acquired pixel data enables the system to perceive and reason about interface elements solely through visual information.

Based on the acquired pixel data and the natural-language instruction, the system generates a plan comprising one or more user-interface operations, wherein each operation is referenced to one or more pixel regions of the graphical user interface. In certain embodiments, generating the plan comprises jointly processing the pixel data, the natural-language instruction, and application map information or crawl-derived associations describing user-interface elements of the software application. The application map information may be derived from prior automated exploration, historical interaction traces, or learned associations across multiple instances or layouts of the application, thereby improving localization and semantic understanding of interface elements.

In one embodiment, generating the plan further comprises producing region heatmaps that localize interactive user-interface elements within the pixel data and binding each localized element to an interaction primitive selected from click, tap, drag, scroll, keypress, submit, or type. The resulting plan therefore specifies both an interaction type and a pixel-referenced target region, enabling precise and visually grounded execution of interface actions.

Execution of the plan comprises injecting an operating system-level input event at coordinates derived from a referenced pixel region, such that the input event is indistinguishable from a human-generated mouse or keyboard action. Prior to injecting the input event, the system may perform coordinate transformations to account for device pixel ratio, window origin, viewport scroll position, screen orientation, or display scaling, thereby ensuring accurate execution across different devices, resolutions, and configurations.

After executing at least one user-interface operation, the system performs closed-loop verification by re-acquiring pixel data representing a subsequent visual state of the graphical user interface and determining whether the user goal is satisfied based on the re-acquired pixel data. In certain embodiments, the verification process comprises comparing an observed outcome derived from the re-acquired pixel data to a predicted outcome and determining whether a divergence exceeds a threshold. When such divergence is detected, the system may re-localize a target pixel region, re-plan one or more user-interface operations, or fall back to selector-based execution using pre-existing mappings associated with a parent virtual agent system, thereby enabling robust recovery from execution errors or unexpected interface changes.

In some embodiments, prior to executing an operating system-level input event, the system simulates a predicted next graphical user interface state using a world action model and computes a value metric associated with a candidate action. The system selects the candidate action based on the value metric, thereby preferring actions predicted to advance the user goal or reduce execution risk. The world action model may be trained using transition triples, each comprising a screen state represented by pixel data, an action comprising a user-interface action or tool invocation, and a subsequent screen state represented by pixel data, with such transition triples obtained from multiple instances of the software application across different devices or viewports.

In one embodiment, the method further comprises iteratively executing a planning loop that includes observing pixel data and tool outputs, proposing a candidate user-interface action or tool invocation, simulating an outcome using the world action model, acting by injecting the operating system-level input event or invoking the tool, and verifying the result by re-acquiring pixel data, with the loop repeating until the user goal is satisfied or a stop condition is reached. This iterative process enables adaptive, human-like interaction with complex or dynamically changing graphical user interfaces.

In certain embodiments, inference associated with plan generation, simulation, or verification is dynamically routed between a local on-device model and a remote model based on one or more factors including model confidence, privacy classification of the pixel data, device resource availability, network latency, user-interface complexity, or action risk. This adaptive routing enables efficient use of computational resources while preserving privacy and responsiveness.

In one embodiment, generating the plan comprises using a non-generative masked-latent encoder configured to predict masked region representations from surrounding pixel context without reconstructing pixel-level data. This approach reduces computational overhead and limits exposure of raw visual information while preserving semantic understanding of interface elements. In certain embodiments, the on-device model is trained using federated learning, wherein model updates are aggregated across multiple devices without transmitting raw pixel data, thereby enabling continual improvement of the system while maintaining user privacy.

What is claimed is:

1. A computer-implemented method for controlling a graphical user interface (GUI) of a software application executing on a client device, the method comprising:
receiving a natural-language instruction that specifies a user goal;
acquiring pixel data representing a current visual state of the GUI;
generating, based on the pixel data and the natural-language instruction, a plan of one or more user-interface operations referenced to one or more pixel regions of the GUI;
executing at least one user-interface operation of the plan by injecting an operating system-level input event at coordinates derived from a referenced pixel region; and
performing closed-loop verification by re-acquiring pixel data after execution and determining, based on the re-acquired pixel data, whether the user goal is satisfied.

2. The method of claim 1, wherein generating the plan comprises jointly processing (i) the pixel data, (ii) the natural-language instruction, and (iii) application map information or crawl-derived associations that describe one or more user-interface elements of the software application.

3. The method of claim 1, wherein generating the plan comprises producing region heatmaps that localize at least one interactive user-interface element within the pixel data and binding the localized user-interface element to an interaction primitive selected from the group consisting of click, tap, drag, scroll, keypress, submit, and type.

4. The method of claim 1, wherein injecting the operating system-level input event comprises performing coordinate transforms to account for at least one of device pixel ratio, window origin, viewport scroll position, or screen rotation.

5. The method of claim 1, wherein performing the closed-loop verification comprises comparing an observed outcome derived from the re-acquired pixel data to a predicted outcome, and when a divergence exceeds a threshold, performing at least one of re-localizing a target pixel region, re-planning the plan, or falling back to selector-based execution using pre-existing mappings of a parent virtual agent system.

6. The method of claim 1, further comprising, prior to executing the operating system-level input event, simulating, using a world action model, a predicted next GUI state latent and a value metric for a candidate action, and selecting the candidate action based on the value metric.

7. The method of claim 6, wherein the world action model is trained using transition triples each comprising (i) a screen state represented by screen pixels, (ii) an action comprising a user-interface action or a tool invocation, and (iii) a subsequent screen state represented by screen pixels, the transition triples being obtained from multiple instances of the software application across multiple devices or viewports.

8. The method of claim 1, further comprising iteratively executing a planning loop comprising observing pixels and tool outputs, proposing a candidate user-interface action or a tool invocation, simulating an outcome using a world action model, acting by injecting the operating system-level input event or invoking the tool invocation, verifying by re-acquiring pixels, and repeating until a goal condition is satisfied or a stop condition occurs.

9. The method of claim 1, further comprising routing inference between (i) a local on-device model and (ii) a remote model based on at least one of model confidence, privacy classification of the pixel data, device resource availability, network latency, user-interface complexity, or action risk.

10. The method of claim 1, wherein generating the plan comprises using a non-generative masked-latent encoder that predicts masked region representations from surrounding pixel context without reconstructing pixel-level data.

11. The method of claim 1, wherein a model on the client device is learnt using Federated Learning.

12. A computing system for controlling a graphical user interface of a software application, the computing system comprising:
one or more processors; and
a memory storing instructions that, when executed by the one or more processors, cause the computing system to:
acquire pixel data representing a current GUI state;
receive a natural-language instruction specifying a user goal;
generate, by jointly processing the pixel data and the natural-language instruction, a plan of one or more user-interface operations referenced to pixel regions;
execute at least one operation of the plan by injecting operating system-level input events at coordinates derived from the referenced pixel regions; and
verify progress by re-acquiring pixel data after execution and using the re-acquired pixel data to determine whether the user goal has been achieved.

13. The computing system of claim 12, wherein the instructions further cause the computing system to generate, using a joint embedding predictive architecture (JEPA) encoder, latent representations of masked regions of the GUI state and action embeddings aligned to user-interface regions or tool signatures.

14. The computing system of claim 13, wherein the JEPA encoder is trained using at least one of region masking, multi-scale crops, interface theme, and DPI randomization.

15. The computing system of claim 12, further comprising a world action model configured to predict, from a current latent screen state and a candidate action embedding, (i) a next latent screen state and (ii) a success probability of satisfying the user goal.

16. The computing system of claim 15, wherein the instructions further cause the computing system to validate a candidate action by comparing a predicted outcome from the world action model to an observed outcome derived from the re-acquired pixel data.

17. The computing system of claim 12, further comprising a tool router configured to select between (i) injecting the operating system-level input events and (ii) invoking an external tool or application programming interface (API), and to ingest a tool result as an observation for a subsequent iteration.

18. The computing system of claim 17, wherein the tool result comprises a structured response that is embedded and concatenated to a state representation used to select a subsequent user-interface operation.

19. The computing system of claim 12, further comprising a gate configured to route inference between a local on-device model and a remote model based on at least a privacy tier and a resource availability metric.

20. The computing system of claim 19, wherein the gate enforces a rule that a GUI state containing personally identifiable information (PII) is processed using the local on-device model.

21. The computing system of claim 12, wherein, upon a divergence between predicted and observed outcomes exceeding a threshold, the computing system self-corrects by re-localizing a target pixel region and re-planning, or falls back to selector-based execution.

22. The computing system of claim 12, wherein a model on the computing system is learnt using Federated Learning.
